(19) United States
(12) Patent Application Publication
(10) Pub. No.: US 2013/0080293 A1
(43) Pub. Date: Mar. 28, 2013

(54) MANUFACTURING SUPPLY CHAIN MANAGEMENT

(71) Applicants: Maung (Bob) A. Khin, North Aurora, IL (US); Jeff Klingler, Valparaiso, IN (US); Alex F. Jonard, St. Charles, IL (US); David S. Hallin, Cary, IL (US)

(72) Inventors: Maung (Bob) A. Khin, North Aurora, IL (US); Jeff Klingler, Valparaiso, IN (US); Alex F. Jonard, St. Charles, IL (US); David S. Hallin, Cary, IL (US)

(21) Appl. No.: 13/247,061

(22) Filed: Sep. 28, 2011

(51) Int. Cl. G06Q 30/06; G06Q 50/22

(52) U.S. Cl. 705/26.81

(57) ABSTRACT

Systems, methods, computer readable media, and devices for managing a manufacturing supply chain to ensure compliance with industry-specific and federal standards from the time the material is supplied by a vender to the time a product is provided to a customer. In some embodiments, a system for managing a supply chain includes a variety of databases (e.g., a customer database, a vendor database, a risk management database, a validation database, etc.). The databases store information associated with material vendors, customers, risk assessments, control parameters, and validation or qualification information related to the use of machines and manufacturing processes. This information is used to process a purchase order and ensure that a customer receives a corresponding quote fulfilling the order and including materials that are in compliance with the customer's own manufacturing and materials standards, as well as any relevant federal and industry-specific standards.

### BACKGROUND

This invention relates to systems, methods, devices, and computer readable media for supply chain management. For example, bar stock (e.g., stainless steel, carbon steel, aluminum, brass, cobalt-chrome-molybdenum [“CCM”], titanium, plastics, etc.) or material is used by original equipment manufacturers (“OEMs”) for a variety of applications and in a variety of industries. For example, material is machined and manufactured for use in automotive applications, aerospace applications, medical devices and instruments, and medical implants. Each of these applications may have different standards of compliance with which the material must comply. For example, manufacturers or producers of medical implants have strict standards for the materials that are used in the manufacturing process.

### SUMMARY

Strict compliance with standards associated with some industries or specific applications of materials is difficult to trace from, for example, a particular country of origin, melt source, or an intermediate or finishing mill through an end-user or customer. Additionally, materials that are used in medical implants also must comply with United States Food and Drug Administration (“FDA”) regulations related to material certification and validation protocols (e.g., equipment, processes, products, etc.), as well as restriction of hazardous materials (“RoHS”) requirements, and Department of Defense federal acquisition regulation supplement (“DFARS”) requirements. Complicating the traceability, certification, and validation requirements of certain industries and material applications is the number and variety of different materials, material grades, machining equipment, and machining processes (e.g., turning, straightening, grinding, sawing, chamfering, heat treating, plating, cryogenically treating, nondestructive (“NDT”) testing, etc.) associated with manufacturing a product.

As such, the invention provides systems, methods, devices, and computer readable media for managing a manufacturing supply chain to ensure compliance with industry-specific and federal (e.g., CFR 820) and International (e.g., ISO 9001, 13485, etc.) standards from the time the material is supplied by any of a plurality of vendors (e.g., mills, foundries, etc.) to the time a product is provided to any of a plurality of customers (e.g., OEMs). A system for managing such a supply chain includes a variety of databases (e.g., a customer database, a vendor database, a risk management database, a validation database, etc.). The databases store information associated with material vendors, customers, risk assessments, control parameters, and validation or qualification information related to the use of machines and manufacturing processes. This information is used to process a purchase order and ensure that a customer receives a corresponding quote fulfilling the order and including materials that are in compliance with their own manufacturing and materials standards, as well as any relevant federal and industry-specific standards.

In one embodiment, the invention provides a system for managing a manufacturing supply chain to fulfill an order for a medical grade material and generate a corresponding service quote. The system includes a customer database, a vendor database, a risk analysis database, and a controller. The customer database is configured to store a set of customer data for each of a plurality of customers. The vendor database is configured to store a set of vendor data for each of a plurality of vendors. The set of vendor data includes at least one raw material capable of being supplied by the vendor, and the at least one raw material has an associated raw material characteristic. The risk analysis database is configured to store a set of risk analysis data related to at least one manufacturing process. The risk analysis data is associated with an effect on the at least one raw material by the at least one manufacturing process. The controller includes a resource planning module and is configured to receive the order for the medical grade material from one of the plurality of customers. The order includes an attribute of the medical grade material, and the medical grade material is associated with the at least one manufacturing process. The controller is also configured to retrieve the set of customer data associated with the one of the plurality of customers from the customer database and select one of the plurality of vendors to provide the at least one raw material based on the set of vendor data stored in the vendor database, a comparison of the attribute of the medical grade material to the raw material characteristic, and the risk analysis data in the risk database associated with the effect on the at least one raw material by the manufacturing process. The controller is also configured to generate the service quote based on the comparison of the attribute of the medical grade material to the raw material characteristic. The service quote includes the attribute of the medical grade material, the selected one of the plurality of vendors, and the raw material characteristic.

In another embodiment, the invention provides a computer-implemented method of fulfilling an order for a material. The method includes storing, in a vendor database, vendor data relating to a plurality of raw material vendors. The vendor data includes vendor attribute data related to at least one attribute of the vendor and raw material attribute data related to at least one attribute of a raw material. The method also includes receiving an order for the material from a customer and storing, in a customer database, customer data relating to the customer. The customer data including customer requirements data related to at least one customer requirement for the material. The method also includes determining, by a processor, whether the at least one attribute of the raw material is indicative of the raw material being capable of being used in a medical device, and determining, by the processor, order fulfillment information including a vendor among the plurality of raw material vendors and the raw material. The order fulfillment information is determined based on the stored customer data and the determination of whether the at least one attribute of the raw material is indicative of the raw material being capable of being used in the medical device.

In another embodiment, the invention provides a method of processing an order for a material and generating a service quote. The method includes storing a set of customer data relating to each of a plurality of customers in a customer database. The set of customer data includes one or more customer specifications related to the material. The one or more customer specifications include at least one customer attribute of the material related to an application of the material. The method also includes storing a set of vendor data relating to each of a plurality of raw material vendors in a vendor database. The set of vendor data includes at least one vendor attribute for each of the plurality of vendors, at least one raw material the vendors are capable of supplying, and at least one raw material attribute associated with the at least one raw material. The method also includes receiving the order for the material from one of the plurality of customers, accessing the at least one customer attribute from the customer database, accessing the at least one vendor attribute and the at least one raw material attribute from the vendor database, comparing the at least one customer attribute to the at least one raw material attribute for each of the plurality of vendors, and determining which of the plurality of raw material vendors is capable of supplying the raw material based on the vendor attribute. The method then includes selecting at least one of the plurality of vendors to supply the raw material based on the determination of which of the plurality of raw material vendors is capable of supplying the raw material and the comparison.

Other aspects of the invention will become apparent by consideration of the detailed description and accompanying drawings.

### BRIEF DESCRIPTION OF THE DRAWINGS

FIG. 1 illustrates a supply chain management system according to an embodiment of the invention.

FIG. 2 illustrates a supply chain management system according to another embodiment of the invention.

FIG. 3 illustrates a supply chain management system according to another embodiment of the invention.

FIG. 4 illustrates a customer management module according to an embodiment of the invention.

FIG. 5 illustrates a customer management interface according to an embodiment of the invention.

FIG. 6 illustrates a vendor management module according to an embodiment of the invention.

FIG. 7 illustrates a vendor management interface according to an embodiment of the invention.

FIG. 8 illustrates a certifications management interface according to an embodiment of the invention.

FIG. 9 illustrates a risk management module according to an embodiment of the invention.

FIG. 10 illustrates a grade management interface according to an embodiment of the invention.

FIG. 11 illustrates a validation module according to an embodiment of the invention.

FIGS. 12-14 illustrate a validation process according to an embodiment of the invention.

FIGS. 15-16 illustrate a process for quote generation according to an embodiment of the invention.

FIG. 17 illustrates a service quote interface according to an embodiment of the invention.

FIGS. 18-19 illustrate a process for updating a vendor management module according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The invention described herein relates to managing a supply chain for the selection and production of materials for use by original equipment manufacturers (“OEMs”), sub-contractors (e.g., Tier-I and Tier-II sub-contractors), etc. OEMs manufacture products related to a variety of applications, such as medical applications, automotive applications, aerospace applications, etc. The materials used in many of these applications are subject to a variety of restrictions and requirements related to compliance with various standards (e.g., federal, state, foreign, local, and/or industry-wide laws or standards). For example, materials used in medical applications are subject to federal standards associated with quality, adherence, etc. Embodiments of the invention ensure compliance with these standards from the time the material is supplied by a vendor and through machining, processing, and sale to a customer and/or end user. A system for managing such a supply chain includes a variety of databases (e.g., a customer database, a vendor database, a risk management database, a validation database, etc.). The databases store information associated with a plurality of material vendors, a plurality of customers, risk assessments and corresponding control parameters, and qualification information related to the use of machines and manufacturing processes. This information is used by a manufacturing resource planning module (“MRPM”) to process a purchase order to identify order fulfillment information and ensure that a customer receives a corresponding service quote or quotation including materials that are in compliance with the customer's own manufacturing and materials standards, as well as government or other requirements and standards.

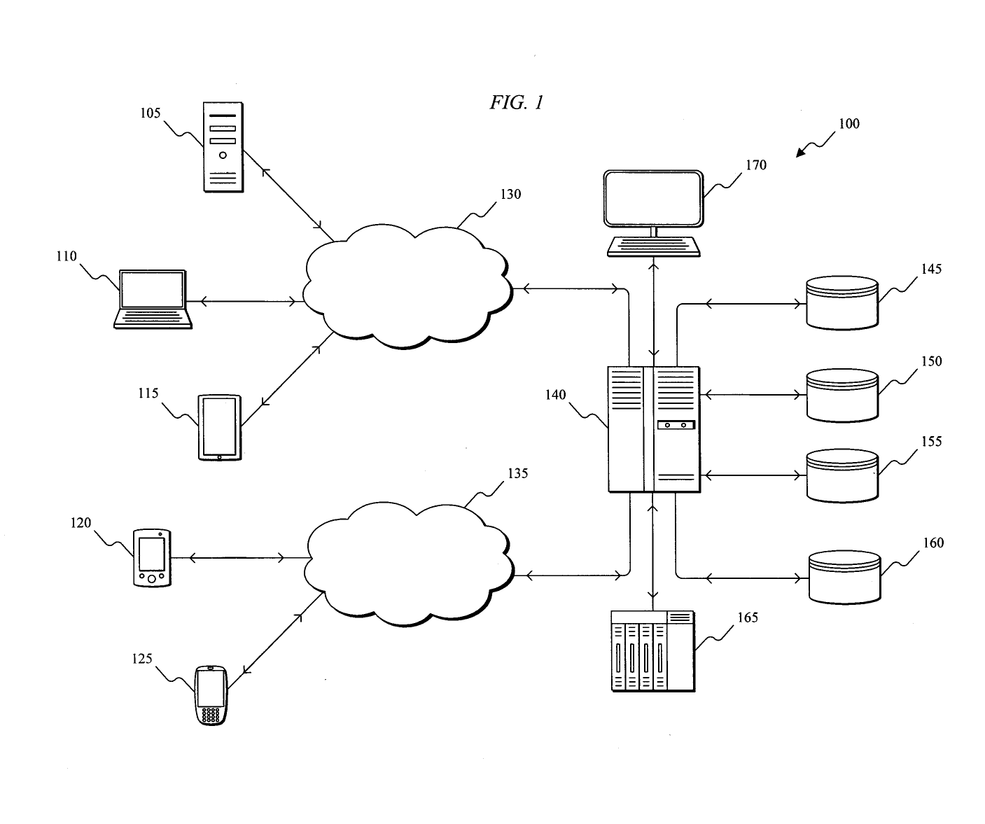

FIG. 1 illustrates a supply chain management system 100 that is configured to receive a purchase order from any of a variety of sources, analyze the purchase order with respect to compliance with a plurality of restrictions (e.g., disallowed melt sources), requirements (e.g., medical grade materials), preferences (e.g., requesting third party validation or certification), and standards, and generate one or more outputs related to a quote or the control of one or more manufacturing devices. The supply chain management system 100 includes a plurality of data input devices 105-125, a first network 130, a second network 135, a controller (e.g., a mainframe computer, a server, etc.) 140, a customer database 145, a vendor database 150, a risk analysis database 155, a validation database 160, a control device 165 (e.g., a programmable logic controller [“PLC”]), and a user interface or workstation 170. The databases 145-160 can be, for example, relational databases. The plurality of data input devices 105-125 include, for example, a server 105, a personal computer 110, a tablet computer 115, a personal digital assistant (“PDA”) (e.g., an iPod touch, an e-reader, etc.) 120, and a mobile phone (e.g., a smart phone) 125. Each of the devices 105-125 is configured to communicatively connect to the controller 140 through the first network 130 and/or the second network 135 and provide, for example, a purchase order or information to one or more of the databases 145-160. The first network 130 is, for example, a wide area network (“WAN”) (e.g., a TCP/IP based network, a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a Digital Enhanced Cordless Telecommunications (“DECT”) network, a Digital AMPS (“IS-136/TDMA”) network, or an Integrated Digital Enhanced Network (“iDEN”) network, etc.)

The second network 135 is, for example, a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In the illustrated embodiment, the first network 130, the second network 135, and the communication between the devices 105-125 and the controller 140 are protected using one or more encryption techniques, such as those techniques provided in the IEEE 802.1 standard for port-based network security, pre-shared key, Extensible Authentication Protocol (“EAP”), Wired Equivalency Privacy (“WEP”), Temporal Key Integrity Protocol (“TKIP”), Wi-Fi Protected Access (“WPA”), etc. The connections between the devices 105-125 and the first and second networks 130 and 135 are, for example, wired connections, wireless connections, or a combination of wireless and wired connections. Similarly, the connections between the controller 140 and the first and second networks 130 and 135 are wired connections, wireless connections, or a combination of wireless and wired connections. The purchase order (or data elements of a purchase order) is transmitted through the first or second networks 130 and 135 to the controller 140 for processing.

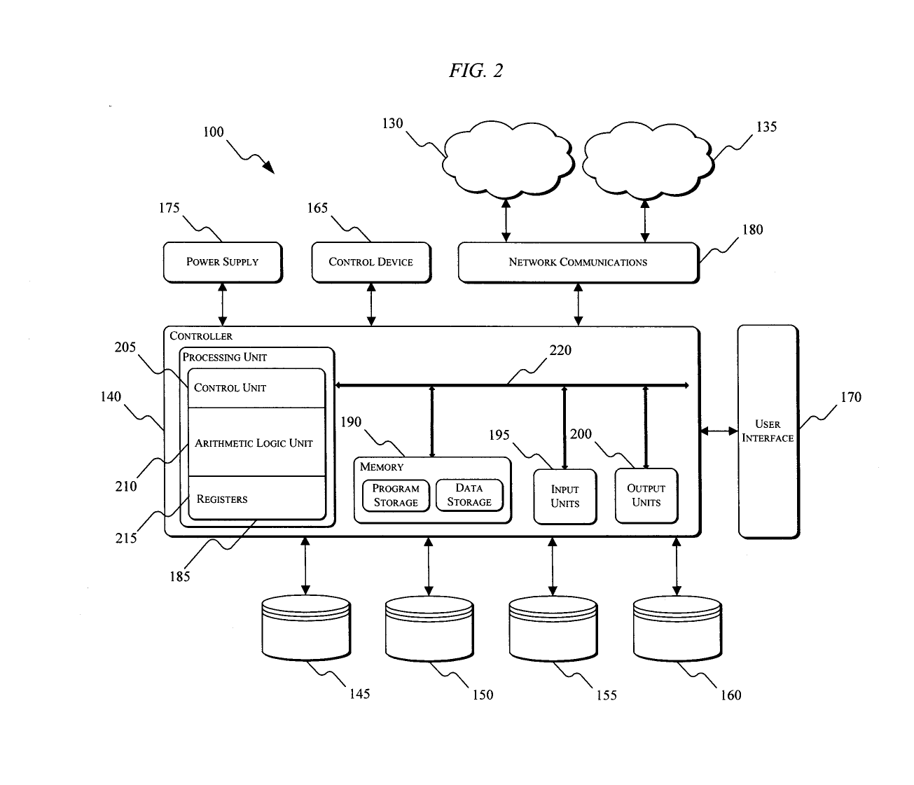

FIG. 2 illustrates the supply chain management system 100 in greater detail with respect to the controller 140. The controller 140 is electrically and/or communicatively connected to a variety of modules or components of the system 100. For example, the illustrated controller 140 is connected to the user interface module 170, the customer database 145, the vendor database 150, the risk analysis database 155, the validation database 160, the control device 165, a power supply module 175, and a network communications module 180. The controller 140 includes combinations of hardware and software that are operable to, among other things, fulfill an order for medical grade material, generate a quote for the production of a material, control a manufacturing device, etc.

In some constructions, the controller 140 includes a plurality of electrical and electronic components that provide power, operational control, and protection to the components and modules within the controller 140 and/or supply chain management system 100. For example, the controller 140 includes, among other things, a processing unit 185 (e.g., a microprocessor, a microcontroller, or another suitable programmable device), a memory 190, input units 195, and output units 200. The processing unit 185 includes, among other things, a control unit 205, an arithmetic logic unit (“ALU”) 210, and a plurality of registers 215 (shown is a group of registers in FIG. 2) and is implemented using a known computer architecture, such as a modified Harvard architecture, a von Neumann architecture, etc. The processing unit 185, the memory 190, the input units 195, and the output units 200, as well as the various modules connected to the controller 140 are connected by one or more control and/or data buses (e.g., common bus 220). The control and/or data buses are shown generally in FIG. 2 for illustrative purposes. The use of one or more control and/or data buses for the interconnection between and communication among the various modules and components would be known to a person skilled in the art in view of the invention described herein. In some embodiments, the controller 140 is implemented partially or entirely on a semiconductor (e.g., a field-programmable gate array [“FPGA”] semiconductor) chip, such as a chip developed through a register transfer level (“RTL”) design process.

The memory 190 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 185 is connected to the memory 190 and executes software instructions that are capable of being stored in a RAM of the memory 190 (e.g., during execution), a ROM of the memory 190 (e.g., on a generally permanent basis), or another non-transitory computer readable medium such as another memory or a disc.

In some embodiments, the controller 140 or network communications module 180 includes one or more communications ports (e.g., Ethernet, serial advanced technology attachment [“SATA”], universal serial bus [“USB”], integrated drive electronics [“IDE”], etc.) for transferring, receiving, or storing data associated with the system 100 or the operation of the system 100. Software included in the implementation of the system 100 can be stored in the memory 190 of the controller 140. The software includes, for example, firmware, one or more applications, program data, filters, rules, one or more program modules, and other executable instructions. The controller 140 is configured to retrieve from memory and execute, among other things, instructions related to the control processes and methods described herein. In other constructions, the controller 140 includes additional, fewer, or different components.

The power supply module 175 supplies a nominal AC or DC voltage to the controller 140 or other components or modules of the system 100. The power supply module 175 is powered by, for example, mains power having nominal line voltages between 100V and 240V AC and frequencies of approximately 50-60 Hz. The power supply module 175 is also configured to supply lower voltages to operate circuits and components within the controller 140 or system 100. In other constructions, the controller 140 or other components and modules within the system 100 are powered by one or more batteries or battery packs, or another grid-independent power source (e.g., a generator, a solar panel, etc.).

The user interface module 170 includes a combination of digital and analog input or output devices required to achieve a desired level of control and monitoring for the system 100. For example, the user interface module 170 includes a display (e.g., a primary display, a secondary display, etc.) and input devices such as touch-screen displays, a plurality of knobs, dials, switches, buttons, etc. The display is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, or the like.

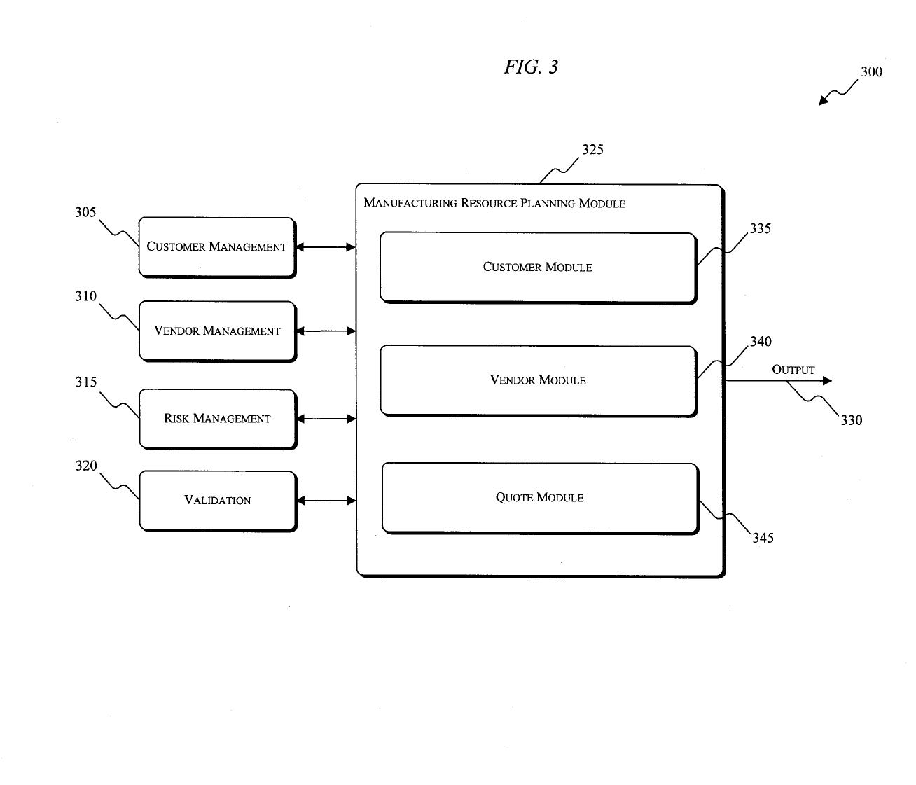

A modular illustration 300 of the supply chain management system 100 described above with respect to FIGS. 1 and 2 is provided in FIG. 3. Each of the modules can include combinations of hardware and software (e.g., program storage memory, data storage memory, executable instructions, etc.). For example, each of the illustrated modules can include executable program instructions stored in the program storage area of the memory 190 and data stored in the data storage area of the memory 190. Each of the illustrated modules is also configured to access or receive information and data stored in at least one of the customer database 145, the vendor database 150, the risk analysis database 155, and the validation database 160. The program instructions can be retrieved and executed by the processing unit 185. The data associated with each of the illustrated modules can also be retrieved by the processing unit 185, and the results associated with the executed program instructions can be written to, for example, the data storage area of the memory 190, the customer database 145, the vendor database 150, the risk analysis database 155, and/or the validation database 160.

Specifically, the system 300 of FIG. 3 includes a customer management module 305, a vendor management module 310, a risk management module 315, a validation module 320, a manufacturing resource planning module (“MRPM”) 325, and an output 330 (e.g., a service quote, a control signals, etc.). The MRPM 325 includes a customer module 335 for receiving and processing information from the customer management module 305, a vendor module 340 for receiving and processing information from the vendor management module 310, and a quote module 345 for generating a product quote based on the processed information from the customer module 335 and the vendor module 340.

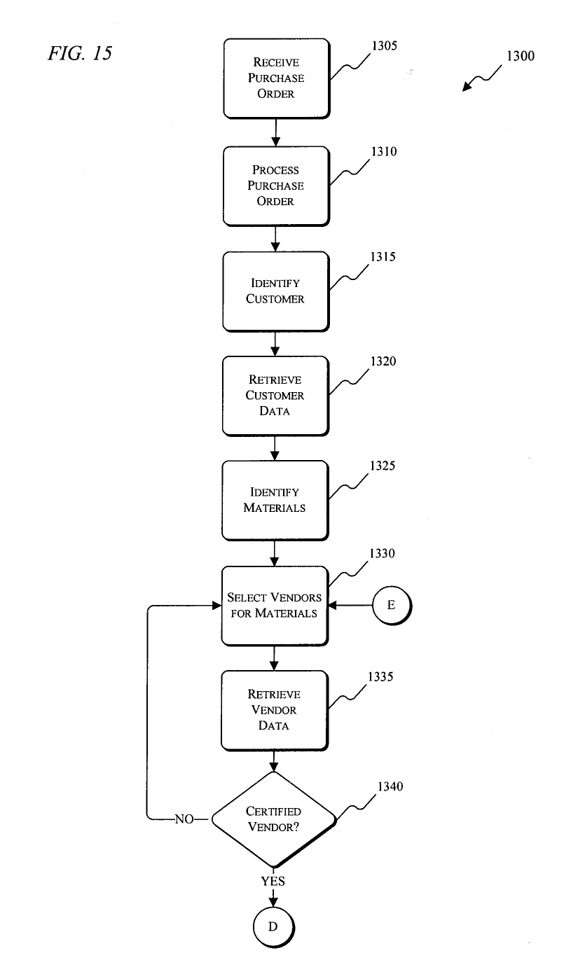

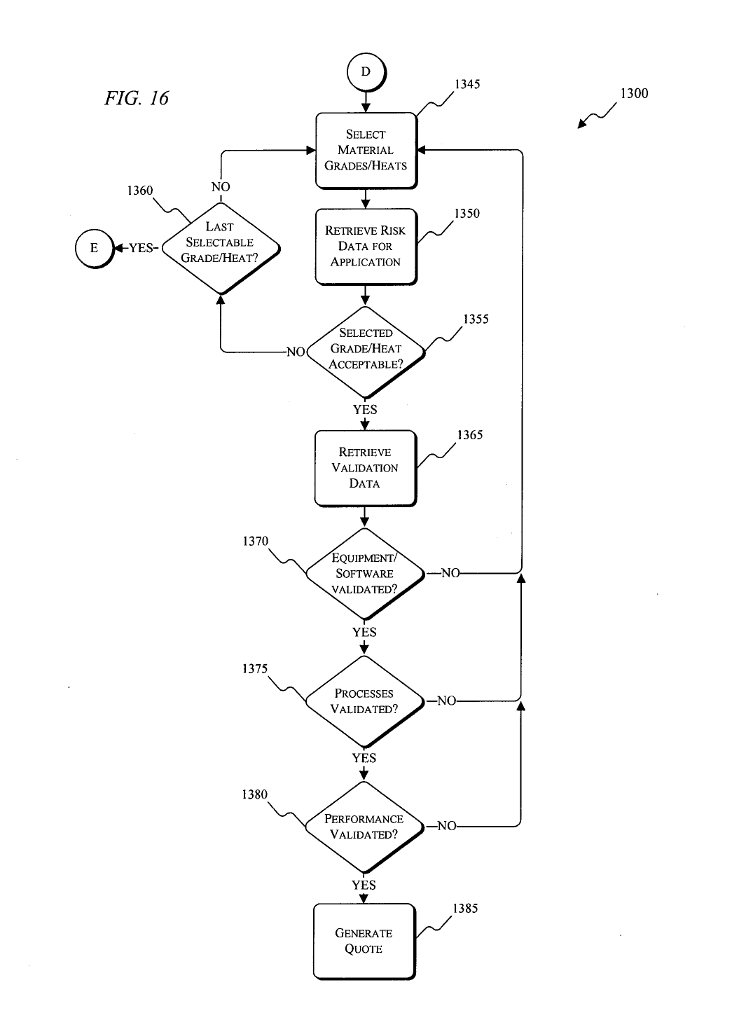

The MRPM 325 receives data and information from each of the modules 305-320 related to a purchase order received from one of the devices 105-125 (e.g., information is automatically received using optical character recognition [“OCR”] technology, is received using a web-based PHP server-side-scripting interface, etc.) or the user interface 170 (e.g., manually entered). Based on the customer that submitted the purchase order, the types of materials in the purchase order, the application for the material, the equipment used in the manufacturing and handling of the material, and/or the processes involved in the manufacturing and handling of the material, each of the modules 305-320 accesses and retrieves corresponding data, processing information, and processing parameters and passes the retrieved data, processing information, and processing parameters to the MRPM 325. The MRPM 325 analyzes the information using the customer module 335, the vendor module 340, and the quote module 345. The MRPM 325 selects materials and material grades having the appropriate characteristics, certifications (e.g., The American Association for Laboratory Accreditation [“A2LA”]), and validations required to produce a product that is compliant with the various industry and application standards (e.g., International Organization for Standardization [“ISO”] 13485, American Society for Testing and Materials [“ASTM”] standards, Society of Automotive Engineers [“SAE”] standards, etc.), and federal standards such as the United States Food and Drug Administration (“FDA”) standards (e.g., FDA 820). The MRPM 325 then generates and outputs a quote identifying the materials selected for the product. The MRPM 325 is described in greater detail below with respect to FIGS. 15 and 16. In some embodiments, the MRPM 325 also generates one or more control signals or control processes that can be used to automatically control the identification, selection, labeling, organizing, and/or processing of the material. For example, the MRPM 325 generates one or more control signals that are sent to a programmable logic controller (“PLC”) or another suitable control device that is configured to control a manufacturing process or machine. The MRPM 325 is also configured to generate audit-trails which can provide a comprehensive listing and/or analysis of changes that have been made to the system 100 (e.g., changes to the customer database 145, the vendor database 150, the risk analysis database 155, the validation database 160, the memory 190, as well as other components or modules within the system 100). Each of the modules 305-320 illustrated in FIG. 3 is described in greater detail herein.

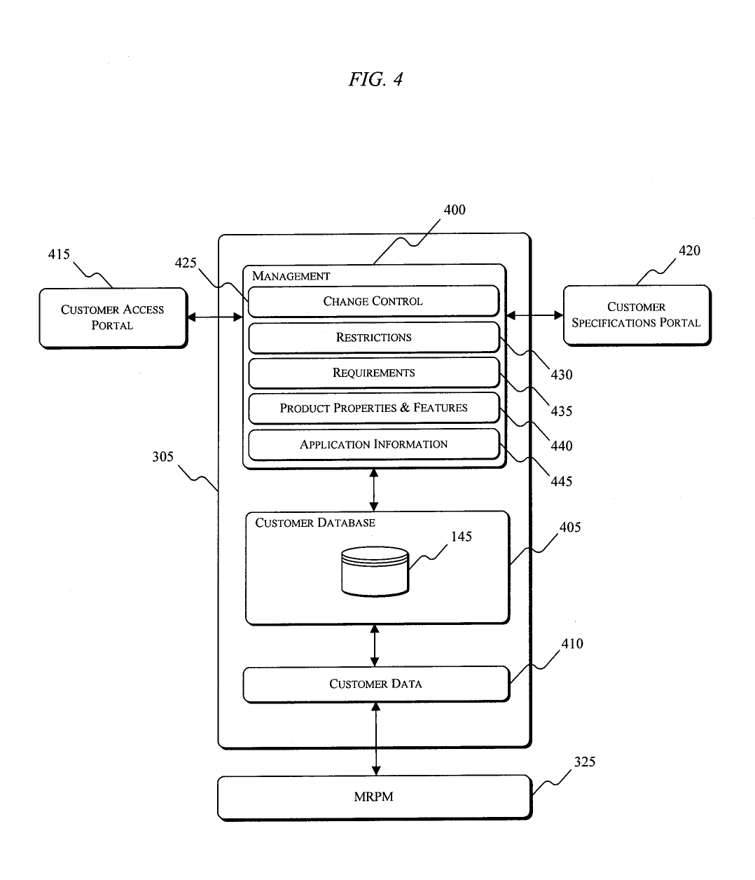

As illustrated in greater detail in FIG. 4, the customer management module 305 includes a management section 400, a customer database section 405 (including the customer database 145), and a customer data section 410. The customer management module 305 is also communicatively connected to a customer access portal 415, a customer specifications portal 420, and the MRPM 325. The customer management module 325 is configured to, for example, store, access, and retrieve customer-specific manufacturing information. In the illustrated embodiment, the management portion 400 of the customer management module 305 includes a change control sub-module 425, a restrictions sub-module 430, a requirements sub-module 435, a product-properties-features (“PPF”) sub-module 440, and an application information sub-module 445.

As an illustrative example of the operation of the customer management module 305, the management section 400 is configured to receive customer product specifications, material restrictions, vendor restrictions, etc., which are, in turn, stored in the customer database section 405. For example, the customer access portal 415 is configured to allow access to, and the review of, the information stored within the customer database section 405. The customer specifications portal 420 is configured to allow the information within the customer database section 405 to be updated or modified. In some embodiments, the management portion 400 of the customer management module 305 is configured as a front-end to the customer management module 305 that enables access to the data within the customer database section 405 from the customer access portal 415 or the customer specifications portal 420. For example, the customer access portal 415 can be configured as a web browser running on one of the devices 105-125. The customer access portal 415 then connects through one of the networks 130 or 135 to the controller 140, accesses a web page (e.g., a HyperText Markup Language [“HTML”] information document) and displays the information on a monitor of the device 105-125. In some embodiments, the interaction between the customer access portal 415 and the controller 140 or customer management module 205 can be enhanced by client-side scripting that allows the customer access portal to, for example, search or modify the customer database section. The customer specifications portal 420 can allow similar access and functionality from, for example, the user interface 170.

The management module 400 includes, for example, executable instructions that access or retrieve information from the customer database section 405 to be displayed on the user interface 170 or otherwise provided to a user. For example, using the customer access portal 415 or the customer specifications portal 420, a user can remotely access change control information, restrictions information, requirements information, PPF information, and application information specific to a customer. The change control information is accessed from the customer database section 405 using the change control module 425. The change control information is associated with, for example, customer information that can be modified by various users of the system 100 (e.g., based on one or more permissions), restrictions or requirements that can be overridden, etc. In some embodiments, the change control information is only accessible by the customer specifications portal 420.

In some embodiments, access permissions can be established that allow, for example, a customer, a customer representative, a compliance organization (e.g., the FDA), etc., to access or modify information stored within the customer database section 405. For example, a customer may be allowed to access the customer database section 405 for the purpose of updating product requirements, vendor restrictions, etc., as described in greater detail below. Additionally or alternatively, an organization such as the FDA may be allowed to access the customer database section 405 and run reports or audits associated with requirements for FDA validation of materials for, among other things, medical implants. Similar permissions can be used with other databases and modules within the system 100.

The restrictions information is accessed from the customer database section 405 using the restrictions sub-module 430. The restrictions information includes, among other things, customer restrictions such as disallowed countries of origin for a material, disallowed melt sources, disallowed finishing mills, disallowed equipment, disallowed materials, and disallowed vendors. The requirements information is accessed from the customer database section 405 by the requirements sub-module 435. The requirements information includes, among other things, restriction of hazardous materials (“RoHS”) requirements, Department of Defense federal acquisition regulation supplement (“DFARS”) requirements, etc. The PPF information is accessed from the customer database section 405 by the PPF sub-module 440. The PPF information can include a variety of customer specific product features and properties that are taken into consideration when selecting materials for a purchase order. For example, the PPF information may include product specific requirements for various chemical or physical properties of a material (e.g., chemical composition, tensile strength, yield strength, etc.). The application information is accessed from the customer database section 405 by the application information sub-module 445. The application information includes customer specific product information associated with the application or field-of-use of the product. For example, as described above, a customer that produces medical implants or other medical products must use materials that are in compliance with various standards (e.g., quality, country of origin, etc.). The application information includes such information for specific customer products because standards may differ from product to product. For example, a customer may produce different products that have different application-based requirements. As a result, a general customer-wide restriction or requirement cannot be used for every product that the customer produces. Instead, the restrictions and requirements that are common to all of a customer's products are stored in the restriction information and the requirements information, respectively. The application specific restrictions and requirements can be stored as application-specific information.

In addition to accessing and modifying information stored within the customer database section 405, the customer management module 305 is also configured to receive information related to a received purchase order (e.g., from the MRPM 325). The information contained within the purchase order can be manually entered or automatically provided to the customer management module 305 (e.g., the information is automatically extracted and routed to the customer management module 305). When information corresponding to the purchase order is received, the management portion 400 is configured to automatically retrieve associated customer information from the customer database section 405 and provide or instruct the customer database section 405 to provide such information to the customer data section 410. In some embodiments, the customer data section 410 is configured to temporarily store the accessed information from the customer database section 305 associated with the received purchase order prior to such information being provided to the MRPM 325. The customer data section 410 can also be configured to store information associated with multiple (e.g., two or more) purchase orders that are processed simultaneously (e.g., as a batch) or consecutively. When all of the associated information from the customer database section 405 corresponding to the purchase order(s) has been accessed and provided to the customer data section 410, the customer data section 410 provides the retrieved information to the MRPM 325 for further processing, as described below. In some embodiments, the customer data section 410 allows the MRPM 325 to access the information stored therein.

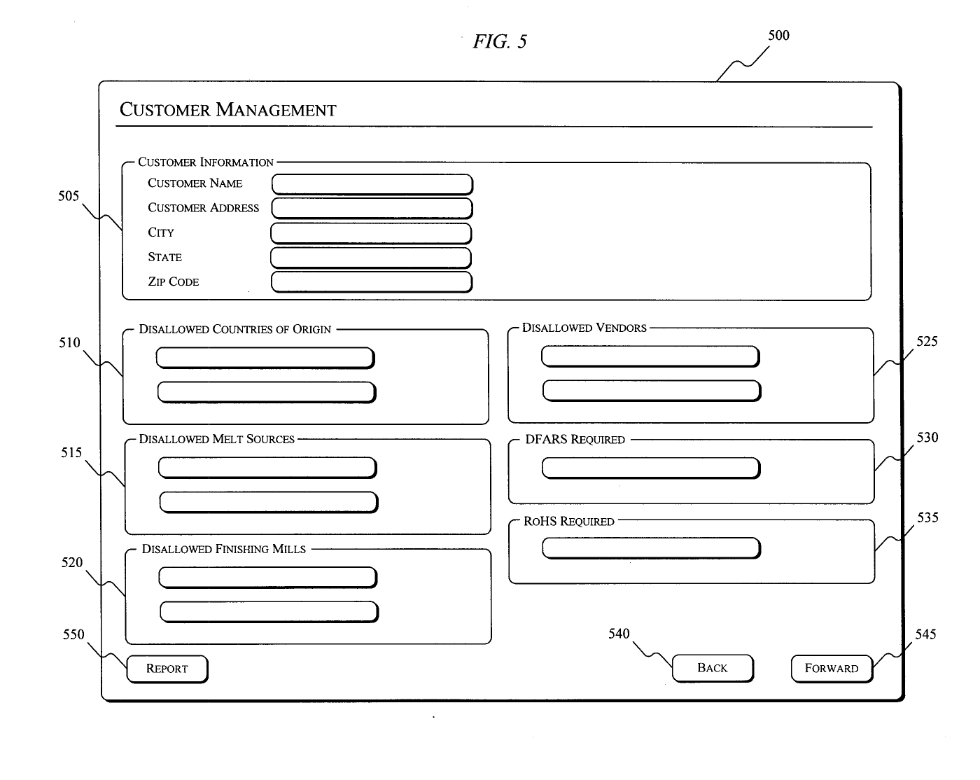

FIG. 5 illustrates a customer management interface 500 associated with the customer management module 305. The customer management interface 500 is configured to be provided to a user on, for example, a display or monitor. The customer management interface 500 can provide customer specific information from the customer database section 405. The information is, for example, general customer information, product specific information, information associated with a specific purchase order, etc. In the illustrated customer management interface 500, the interface 500 includes a customer information section 505, a disallowed country of origin section 510, a disallowed melt sources section 515, a disallowed finishing mills section 520, a disallowed vendors section 525, a DFARS required section 530, and a RoHS required section 535. In some embodiments, the customer management interface 500 can include exceptions to, among other things, disallowed vendors, disallowed finishing mills, etc. For example, in such embodiments, a vendor may be allowed, but particular products, services, equipment, processes, etc., that the vendor produces or uses can be disallowed. The customer information section 505 includes information such as customer name, customer address, city, state, and zip code. In other embodiments, the customer management interface 500 includes additional sections or additional screens which can be navigated using a “BACK” button 540 and a “FORWARD” button 545. For example, one or more of the screens associated with the customer management interface 500 include the PPF information, the application information, the change control information, etc. The customer management interface 500 also includes a report button 550 that, when selected, allows a user to generate a report corresponding to, for example, customer specifications such as change controls, restrictions, requirements, PPF information, application information, compliance information, validation information, etc., related to one or more customers. In some embodiments, the customer management interface 500 can be used to update or modify information in the customer database section 405.

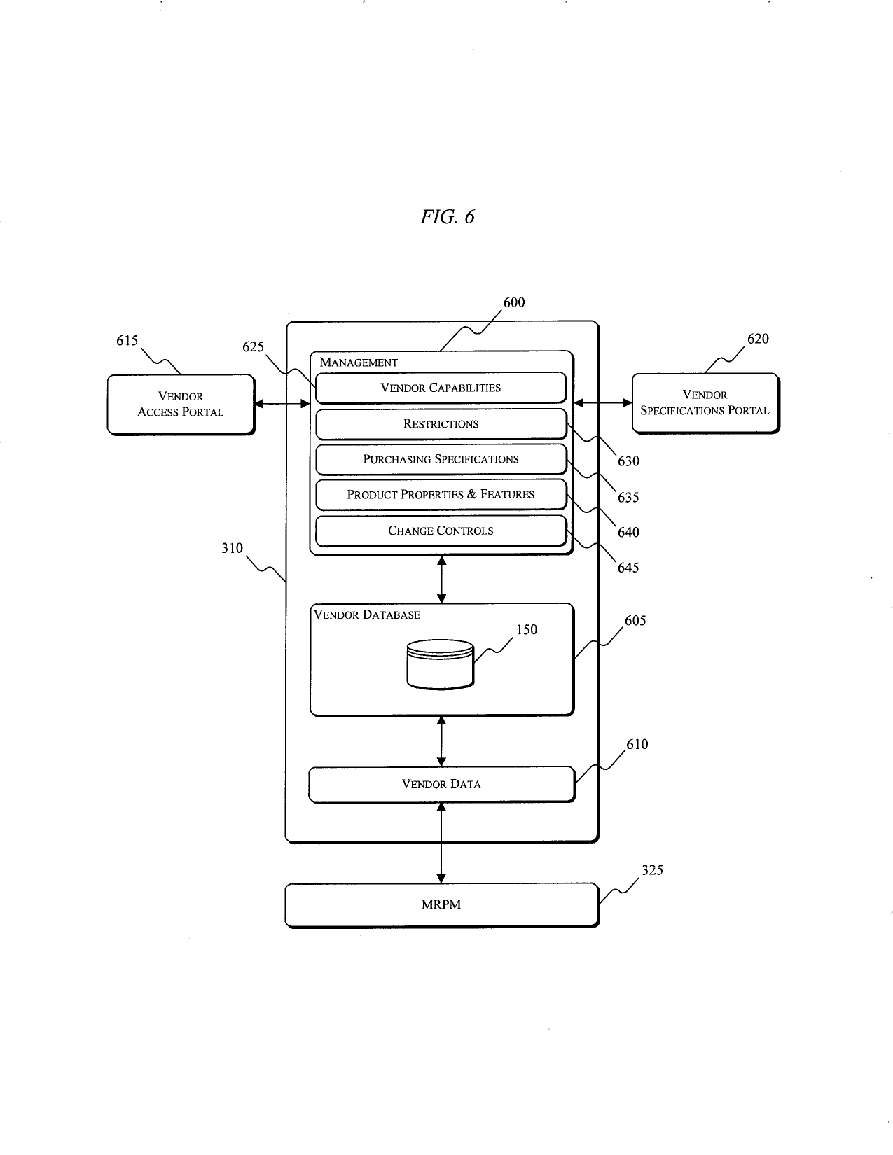

FIG. 6 illustrates the vendor management module 310 of FIG. 3, which includes a management section 600, a vendor database section 605 that includes the vendor database 150, and a vendor data section 610. The vendor management module 310 operates in a similar manner to the customer management module 305 described above with respect to FIG. 4. The vendor management module 310 is also communicatively connected to a vendor access portal 615, a vendor specifications portal 620, and the MRPM 325. The vendor management module 310 is configured to, for example, store, access, and retrieve vendor-specific manufacturing information. In the illustrated embodiment of the vendor management module 310, the management portion 600 includes a vendor capabilities sub-module 625, a restrictions sub-module 630, a purchasing specifications sub-module 635, a PPF sub-module 640, and a change controls sub-module 645.

As an illustrative example of the operation of the vendor management module 310, the management section 600 is configured to receive and store (in the vendor database section 605) vendor production capabilities, material restrictions, approved products, approved processes, purchasing specifications, quality analysis information and certifications, self-audit information, on-site audit information (e.g., change controls, vendor analysis, vendor ranking, etc.), etc. For example, the vendor access portal 615 is configured to allow access to and the review of the information stored within the vendor database section 310. The vendor specifications portal 620 is configured to allow the information within the vendor database section 605 to be updated or modified. In some embodiments, the management portion 600 of the vendor management module 310 is configured as a front-end to the vendor management module 310 that enables access to the data within the vendor database section 605 from the vendor access portal 615 or the vendor specifications portal 620. For example, the vendor access portal 615 can be configured as a web browser running on one of the devices 105-125. The vendor access portal 615 then connects through one of the networks 130 or 135 to the controller 140, accesses a web page and displays the information on a monitor of the devices 105-125. In some embodiments, the interaction between the vendor access portal 615 and the controller 140 or the vendor management module 310 can be enhanced by client-side scripting that allows the vendor access portal 615 to, for example, search or modify the vendor database section 605. The vendor specifications portal 620 can allow similar access and functionality from, for example, the user interface 170.

The vendor management section 600 includes, for example, executable instructions that retrieve information from the vendor database section 605 to be displayed on a user interface 170 or otherwise provided to a user. For example, using the vendor access portal 615 or the vendor specifications portal 620, a user can access vendor capabilities information, restrictions information, purchasing specifications information, PPF information, and change control information specific to a vendor.

The vendor capabilities information is accessed from the vendor database section 605 by the vendor capabilities sub-module 625. The vendor capabilities information includes information related to the raw materials that the vendor is able to provide, services that the vendor is able to provide, vendor certifications, etc. The restrictions information is accessed from the vendor database section 605 using the restrictions sub-module 630. The restrictions information includes, among other things, vendor restrictions related to materials or grades of materials that should not be purchased, disallowed countries of origin for a material, applications for which the vendor cannot provide materials, limitations of equipment, processes that can be performed, etc. The PPF information is accessed from the vendor database section 605 by the PPF module 640. The PPF information can include a variety of specific product features and properties for which a vendor is capable of providing compliant materials. For example, the PPF information may include specialized materials having various chemical (e.g., chemical composition) or physical properties (e.g., tensile strength, yield strength, etc.) that are intended for use in specific products (e.g., medical implants, etc.). The change control information is accessed from the vendor database section 605 using the change control sub-module 645. The change control information is associated with, for example, vendor information that can be modified by various users of the system 100 (e.g., based on one or more permissions), restrictions or requirements that can be overridden, etc. In some embodiments, the change control information is only accessible by the vendor specifications portal 620.

In some embodiments, access permissions can be established that allow, for example, a vendor, a vendor representative, a compliance organization (e.g., the FDA), etc., to access or modify information stored within the vendor database section 605. For example, a vendor may be allowed to access the vendor database section 605 for the purpose of updating vendor capabilities, vendor inventory, vendor restrictions, etc. Additionally or alternatively, an organization such as the FDA may be allowed to access the vendor database section 605 and run reports or audits associated with requirements for FDA validation of materials for, among other things, medical implants.

In addition to accessing and modifying information stored within the vendor database section 605, the vendor management module 310 is also configured to receive information related to a received purchase order (e.g., material, material grade, application, chemical material characteristics, mechanical material characteristics, etc.). The information contained within the purchase order can be manually entered using the vendor specifications portal 620 or automatically provided to the vendor specifications portal (e.g., the information is automatically extracted and routed to the vendor specifications portal 620). When information corresponding to the purchase order is received through the vendor specifications portal 620, the management portion 600 is configured to automatically retrieve associated vendor information from the vendor database section 605 and provide, or instruct the vendor database section 605 to provide, such information to the vendor data section 610. In some embodiments, the vendor data section 610 is configured to temporarily store the accessed information from the vendor database section 605 associated with the received purchase order prior to such information being provided to the MRPM 325. The vendor data section 610 can also be configured to store information associated with multiple (e.g., two or more) purchase orders that are processed simultaneously (e.g., as a batch) or consecutively. When all of the associated information from the vendor database section 605 corresponding to the purchase order(s) has been accessed and provided to the vendor data section 610, the vendor data section 610 provides the retrieved information to the MRPM 325 for further processing, as described below. In some embodiments, the vendor data section 610 allows the MRPM 325 to access the information stored therein.

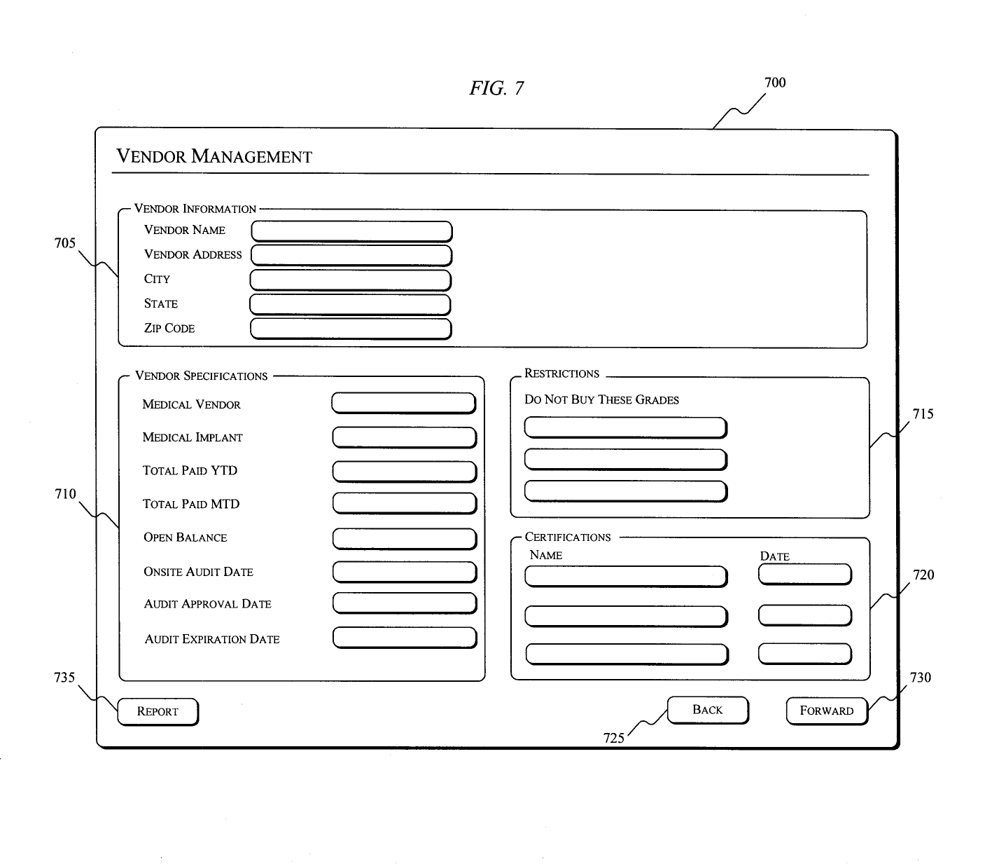

FIG. 7 illustrates a vendor management interface 700 associated with the vendor management module 310. The vendor management interface 700 is configured to be provided to a user on, for example, a display or monitor. The vendor management interface 700 can provide vendor specific information from the vendor database section 605. The information is, for example, general vendor information, material specific (e.g., material grade) information, information associated with a specific purchase order, etc. In the illustrated vendor management interface 700, the interface 700 includes a vendor information section 705, a vendor specifications section 710, a restrictions section 715, and a certifications section 720. The vendor information section 705 includes information such as vendor name, vendor address, city, state, and zip code. The vendor specifications section 710 includes information such as whether the vendor is a medical vendor, whether the vendor is a medical implant vendor, total paid to vendor year-to-date and month-to-date, and open balance with vendor. The vendor specifications section 710 also includes an indication of the last time an on-site audit of the vendor was performed, the date on which the vendor received audit approval, and the date on which the approved audit is set to expire. The restrictions section 715 includes any restrictions on, for example, materials and material grades that the vendor cannot provide, equipment the vendor cannot use, processes the vendor cannot perform, and other capability criteria. Such data can be accumulated, for example, via on-site audits of the vendor. The certifications section 720 includes any certifications that the vendor has received, such as certifications to provide materials for various products, industries, or applications. In other embodiments, the vendor management interface 700 includes additional sections or additional screens which can be navigated using a “BACK” button 725 and a “FORWARD” button 730. For example, one or more of the screens associated with the vendor management interface 700 include the PPF information, the purchasing specifications information, the change control information, etc. The vendor management interface 700 also includes a report button 735 that, when selected, allows a user to generate a report corresponding to, for example, vendor specifications such as vendor capabilities, vendor restrictions, purchasing specifications, PPF information, change controls, compliance information, validation information, etc., related to one or more vendors. In some embodiments, the vendor management interface 700 can be used to update or modify information in the vendor database section 605.

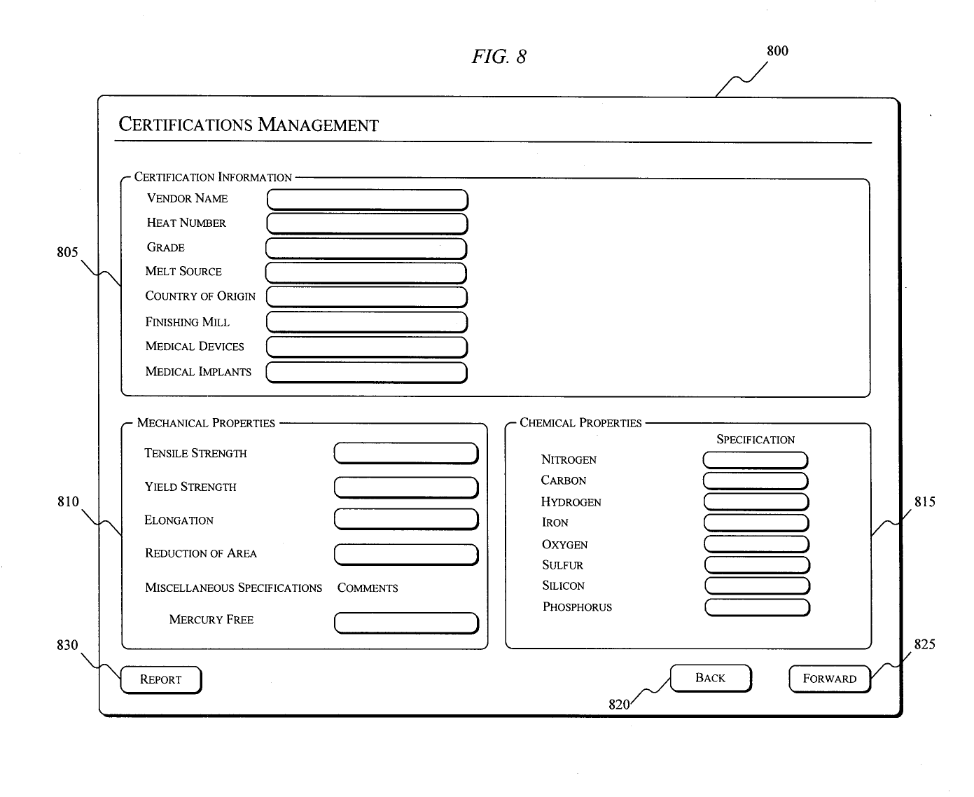

The vendor database section 605 is also configured to store additional information related to, for example, vendor certifications, material grades (described in greater detail below), etc. For example, information associated with each vendor's certifications is stored in the vendor database section 605 and is linked to the vendor management interface 700 such that selecting an illustrated vendor certification retrieves and displays vendor certification information in a certifications management interface, such as the certifications management interface 800 illustrated in FIG. 8. In some embodiments, the certifications management interface 800 is a stand alone interface that can be accessed without first accessing, for example, the vendor management interface 700. The certifications management interface 800 is configured to access and display information from the vendor database section 605 related to a vendor's certifications associated with providing a particular material or grade of material. In some embodiments, the certifications management interface is configured to display each certification associated with a particular vendor. An individual certification can then be selected, and additional information related to that certification can be displayed.

For example, the certifications management interface 800 includes a certification information section 805, a mechanical properties section 810, and a chemical properties section 815. The certifications information section 805 includes information such as vendor name, heat number, material grade, melt source, country of origin, finishing mill, whether the certification applies to medical devices, and whether the certification applies to medical implants. The mechanical properties section 810 includes information such as tensile strength, yield strength, elongation, reduction of area, and miscellaneous specifications (e.g., the material is mercury free). In some embodiments, the mechanical properties section 810 can include additional engineering equations and properties, such as elasticity, Young's modulus, fatigue, etc. The chemical properties section 815 includes information such as nitrogen content, carbon content, hydrogen content, iron content, oxygen content, sulfur content, silicon content, phosphorus content, and other elements from the periodic table of elements. For example, both the mechanical properties section 810 and the chemical properties section 815 can be associated to or communicatively linked with a database of properties that allows additional or different mechanical and chemical properties to be selected. In some embodiments, the certifications management interface 800 can be used to search for certifications by vendor, heat number, grade, a chemical property (e.g., carbon content), mechanical property (e.g., tensile strength, carbon content, heat number, etc.). In some embodiments, the certifications can also be automatically searched to identify a vendor having the necessary certifications to provide materials for products (e.g., medical implants, etc.) having strict compliance standards. Although a variety of certification information, mechanical properties, and chemical properties are illustrated in the certifications management interface 800, additional certification information, mechanical properties, and chemical properties that are known to those skilled in the art to be related to various materials and material grades can also be included in the certifications management interface 800. In some embodiments, the certifications management interface 800 includes additional sections or additional screens (e.g., with additional certification information, certification audit-trails, etc.) which can be navigated using a “BACK” button 820 and a “FORWARD” button 825. The certifications management interface 800 also includes a report button 830 that, when selected, allows a user to generate a report for a certification including the certification information, mechanical properties, chemical properties, etc. In some embodiments, the certifications management interface 800 can be used to update or modify information in the vendor database section 605.

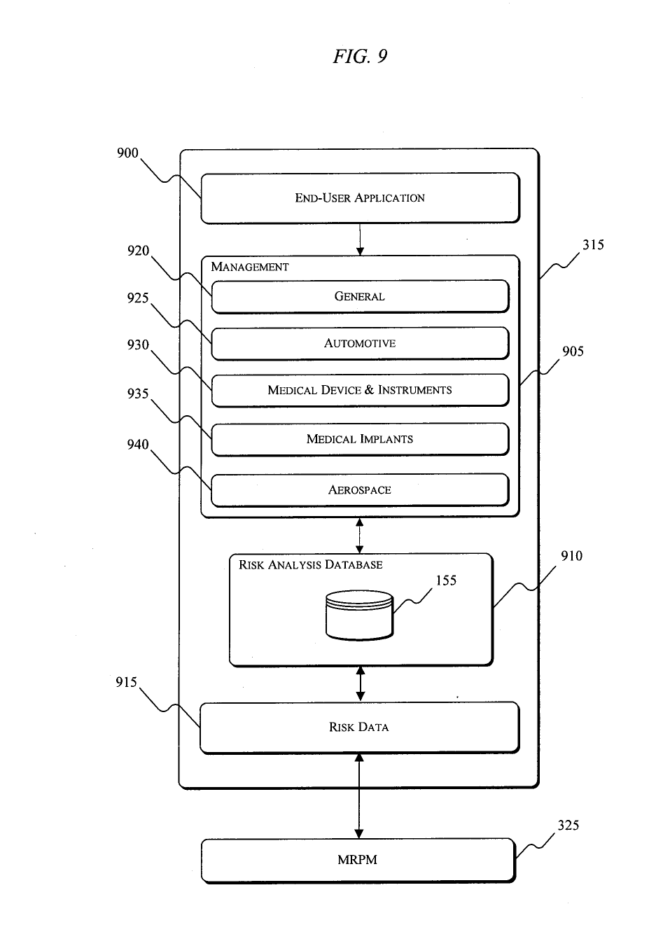

The risk management module 315 of FIG. 3 is illustrated and described in greater detail with respect to FIG. 9. In the illustrated embodiment, the risk management module 315 includes an end-user application section 900, a management section 905, a risk analysis database section 910 (e.g., a failure mode effects analysis (“FMEA”) database) that includes the risk analysis database 155, and a risk data section 915. The end-user application section 900 is configured to receive, for example, information from a purchase order related to the material being ordered and an application (e.g., medical implant, automotive, aerospace, etc.) for the material being ordered. In some embodiments, this information is automatically extracted from the purchase order and provided to the risk management module 315. In other embodiments, the information is manually entered and subsequently provided to the risk management module 315.

The management section 905 includes a general application sub-module 920, an automotive application sub-module 925, a medical devices and instruments applications sub-module 930, a medical implants application sub-module 935, and an aerospace applications sub-module 940. The management section 905 is configured to receive the information from the end-user application section 900 related to the material (e.g., type, grade, etc.) and intended application for the material. Each of the sub-modules 920-940 of the management section 905 is configured to access or retrieve information and data from the risk analysis database section 910 that can be used to identify potential risks associated with the use of the material (e.g., worst-case analysis related to manufacturing processes, manufacturing equipment [e.g., machine overload], etc.) based on the intended application for the material (e.g., application specific standards). The risk database section 910 is configured to store, among other things, risk information associated with an FMEA, such as risk priority numbers (“RPNs”) for the worst case analysis of each process, machine, etc., associated with the processing of a material for a given application. The risk database section 910 also stores instructions corresponding to material grade, equipment, and process selection logic related to the RPN for a given manufacturing process, piece of manufacturing equipment, material, etc.

For example, in identifying a material or grade of material to be used for a particular application, the effects on the material related to selected machining equipment and software, selected processes, selected grades of material, selected sizes of material, worst case processing parameters, worst case machine conditions, etc., are taken into account to ensure an end product's compliance and validation with industry and federal standards (e.g., FDA process, equipment, and software validation) (described below). For example, a particular type of processing (e.g., straightening, grinding, turning, sawing, chamfering, etc.) on a material may result in the material shrinking. The amount of shrinking that occurs is based on, among other things, the softness of the material, the temperature during processing, the type of coolant being used, the size of the material, etc. Following the processing of the material, physical properties of the material can be evaluated (e.g., surface condition, mechanical properties, straightness, etc.). Similar tests and analysis can be performed for other types of material processing. The effects of the processing on the material can then be stored in the risk analysis database section 910. By determining the worst case shrinking associated with the processing, the shrinking can be taken into consideration when selecting the size of the material or the grade of the material for generating a quote in response to a purchase order. The material grade, equipment, and process selection logic is configured to, among other things, select material, material grades, equipment, and processes that prevent or minimize the likelihood of potential failures (e.g., any errors or defects in a manufacturing process, material, etc., that actually or potentially affect the manufacturing of a compliant material, a compliant product, etc.), prevent or reduce the severity of potential failures, mitigate known vulnerabilities (e.g., during material processing), and select remedial actions that reduce cumulative risks.

The management section 905 retrieves the FMEA information (i.e., the RPNs and logic) from the risk database section 910 based on the application identified in the received purchase order. In some embodiments, the FMEA analysis for each manufacturing process, material grade, etc., is assigned an RPN for each known application of the material. As such, after the application for the material in the purchase order has been identified, the manufacturing processes, material grades, sizes of materials, etc., that are the most susceptible to manufacturing inconsistencies can be identified. In some embodiments, a complete listing of the risks associated with a particular application of a material are retrieved from the risk database section 910 and provided to the risk data section 915. In other embodiments, only those risks associated with the application of the material that have a RPN above a threshold RPN level are retrieved from the risk database section 910 and provided to the risk data section 915. The RPN threshold level can be set, established, or determined in a variety of ways. For example, an RPN threshold value for each manufacturing process, material grade, etc., can be determined for each of the known applications of the material. After the risks and logic associated with the end-user's application have been identified, retrieved, and provided to the risk data section 915, the risk data section 915 provides the information to the MRPM 325 for further processing, as described below. In some embodiments, the risk data section 915 allows the MRPM 325 to access the information stored therein.

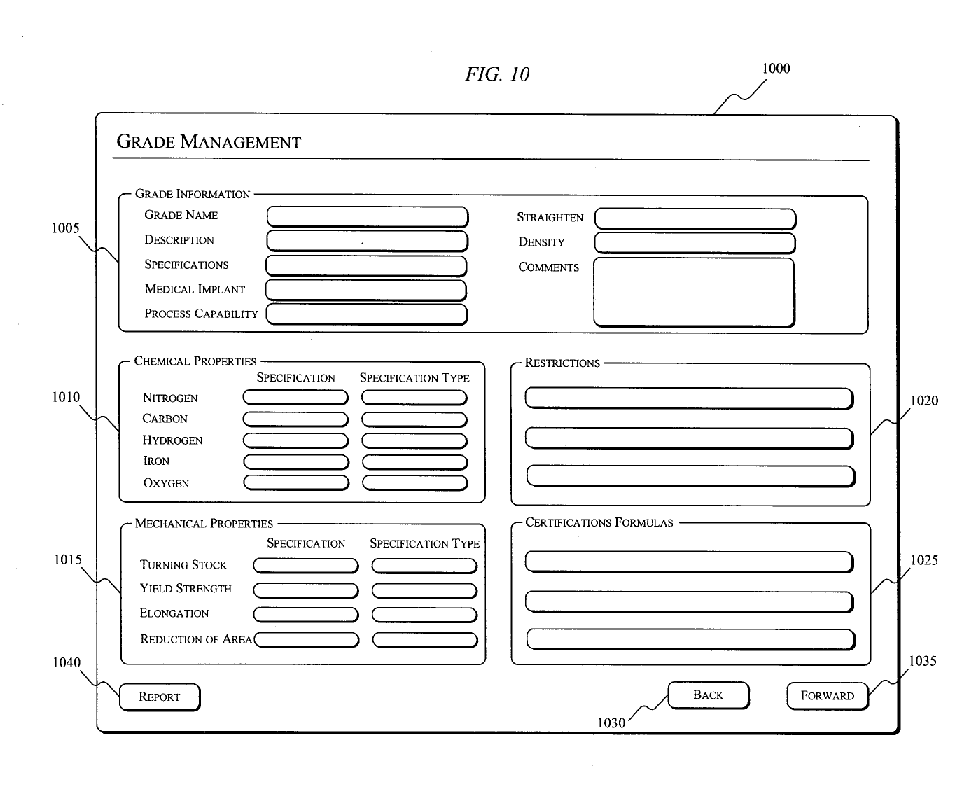

In selecting materials, material grades, equipment, and manufacturing processes as described above, a comprehensive analysis of and understanding of materials and material grades, as well as the effects of equipment and manufacturing processes on those materials and material grades, should be considered. As such, for each material grade that is available from a vendor, a listing or repository of information associated with the material grade is stored in, for example, the vendor database section 605. This information can be assessed by the customer management module 305, the vendor management module 310, the risk management module 315, the validation module 320, and the MRPM 325 for, among other things, updating the information, searching the information, comparing the information, etc. The material grade information can also be accessed using a grade management interface, such as the grade management interface 1000 illustrated in FIG. 10.

For example, the grade management interface 1000 provides information related to attributes of each material that is available for ordering and includes a grade information section 1005, a chemical properties section 1010, a mechanical properties section 1015, a restrictions section 1020, and a certifications formulas section 1025. The grade information section 1005 includes information such as grade name, grade description, grade specifications, whether the material grade can be used for medical implants, a process capability or process capability factor (“CpK”), whether the material grade can be straightened, and density. The process capability factor can be used to further tighten tolerances during the machining of a material. The chemical properties section 1010 includes information such as specified nitrogen content, carbon content, hydrogen content, iron content, and oxygen content, and the type of each specification (e.g., minimum specification, maximum specification). The mechanical properties section 1015 includes information such as specifications for turning stock, yield strength, elongation, and reduction of area and the type of each specification. The grade management interface 1000 is configured to compile grade information for each grade of each material and combine the grade information with, for example, the FMEA analysis performed with respect to each material grade, piece of machining equipment, manufacturing process, etc. The chemical properties and mechanical properties associated with each of the material grades (e.g., determined according to one or more certifications or certification formulas) can be used to determine any restrictions that should be placed on the material grade.

For example, if a turning operation on a material should be limited to a maximum value to prevent the material from being adversely affected by the turning operation, such a restriction can be noted in the restrictions section 1020. In some embodiments, the restrictions section 1020 can identify, for example, an RPN for each manufacturing process, piece of manufacturing equipment, etc., for each application of the material. In other embodiments, the restrictions section 1020 includes only RPNs that exceed the RPN threshold value for an application. The certification formulas section 1025 includes, for example, formulas to calculate whether a particular material grade is certified for a particular application or will remain certified following a manufacturing process. If characteristics of the material grade or manufacturing process result in a value that is within certification parameters (e.g., less than a threshold value, greater than a threshold value, within a certain tolerance, etc.), the material grade can be determined to be certified. In other embodiments of the grade management interface 1000, additional material grade information can also be presented on one or more screens (e.g., accessible using a “BACK” button 1030 and a “FORWARD” button 1035), such as polish information (e.g., removal rate, tolerance, machinability, wheel type, blade type, etc.), finish information (e.g., removal rate, tolerance, machinability, wheel type, blade type, etc.), grind information (e.g., removal rate, tolerance, machinability, wheel type, blade type, etc.), etc. The grade management interface 1000 also includes a report button 1040 that, when selected, allows a user to generate a report for a material grade including the grade information, mechanical properties, chemical properties, restrictions, certification formulas, etc. In some embodiments, the grade management interface 1000 can be used to update or modify information in the vendor database section 605.

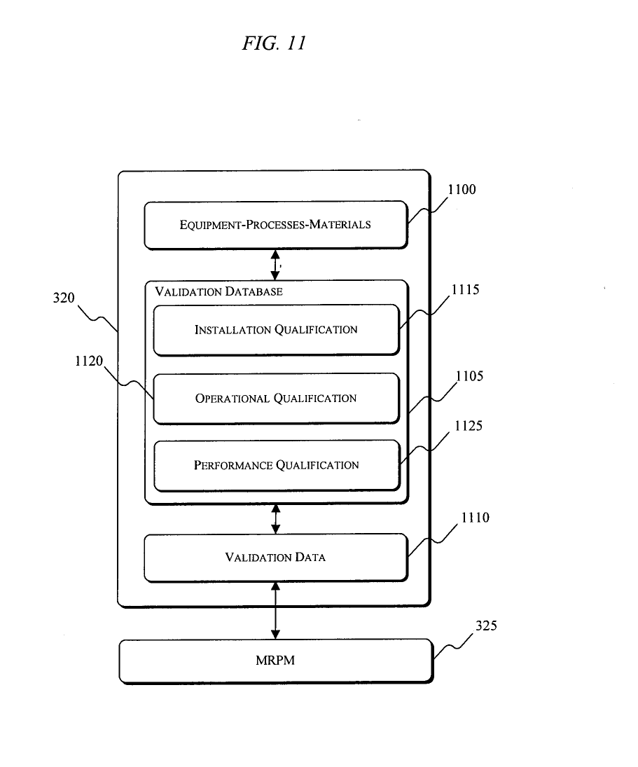

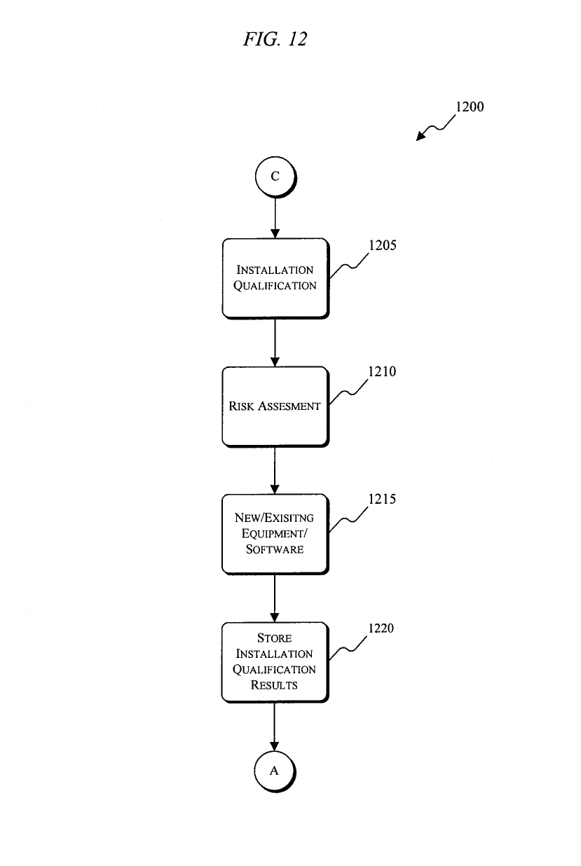

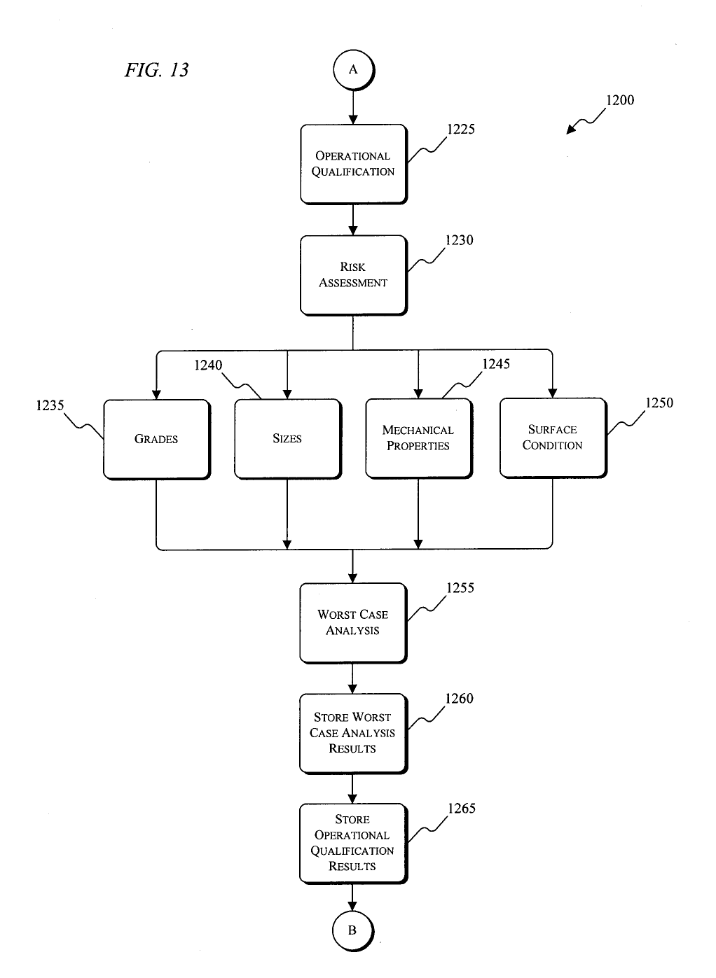

The validation module 320 of FIG. 3 is illustrated and described in greater detail with respect to FIG. 11. The validation module 320 includes an equipment-processes-materials section 1100, a validation database section 1105, and a validation data section 1110. The equipment-processes-materials section 1100 is configured to receive, for example, an indication of the equipment, processes, and materials associated with a purchase order. The equipment-processes-materials section 1100 can receive the indication of the equipment, processes, and materials automatically based on extracted information from a purchase order, or manually (e.g., the indication of the equipment, processes, and materials can be entered using the user interface 170). Based on the information from the purchase order, the validation module 320 is configured to retrieve information corresponding to which of the various equipment, processes, and materials associated with the purchase order have been properly validated (e.g., per FDA 820 validation guidelines). Validation information is stored in the validation database section 1105, which includes an installation qualification (“IQ”) sub-section 1115, an operations qualification (“OQ”) sub-section 1120, and a performance qualification (“PQ”) sub-section 1125 within the validation database 160. The information stored in each of the IQ sub-section 1115, the OQ sub-section 1120, and the PQ sub-section 1125 is described in greater detail below with respect to FIGS. 12 and 13. In operation, the equipment-processes-materials section 1100 accesses the validation information in the validation database section 1105 associated with the equipment, processes, and materials related to a received purchase order, and the validation information is provided to the validation data section 1110. After the validation information for each piece of equipment, process, and material associated with the purchase order has been provided to the validation data section 1110, the validation information is provided to the MRPM 325. In some embodiments, the validation data section 1110 allows the MRPM 325 to access the information stored therein.

A process 1200 for validating equipment, processes, and performance, as described above with respect to FIG. 11, is illustrated and described with respect to FIGS. 12-14. The validation process 1200 includes steps for performing installation qualification, operational qualification, and performance qualification. At step 1205 of the process 1200, the installation qualification is initiated with respect to equipment and software used throughout the quoting and manufacturing process. The installation qualification involves, for example, verifying that equipment and ancillary systems within the supply chain management system 100 have been installed in accordance with installation drawings and/or installation specifications. The installation qualification also includes, for example, ensuring that software is properly installed and calibrated. At step 1210, a risk assessment is performed to determine a level of risk associated with the installed equipment and software and the potential effects of improperly installed equipment or software. The equipment includes, for example, manufacturing equipment, material handling equipment, auxiliary equipment such as compressors, scales, etc., and quality inspection devices (e.g., for calibration). The software includes, among other things, data collection software, preventative maintenance software, etc. At step 1215, each piece of equipment or software is tested and evaluated to ensure proper installation, configuration, calibration, etc. Following the risk assessment at step 1210, the results of the risk assessment with respect to each new and existing equipment or software can be stored to (or updated in), for example, the validation database section 1105 (step 1220). For both new and existing equipment and software, the risk assessment can also be used to establish, among other things, preventative maintenance schedules. Preventative maintenance schedules can be based on level of risk, frequency of use, etc. In some embodiments, the installation qualification also includes ensuring that all equipment used in the manufacturing process is installed in a manner that facilitates maintenance, adjustments, cleaning, use, etc. Following step 1220, the process 1200 proceeds to section A shown in and described with respect to FIG. 13.

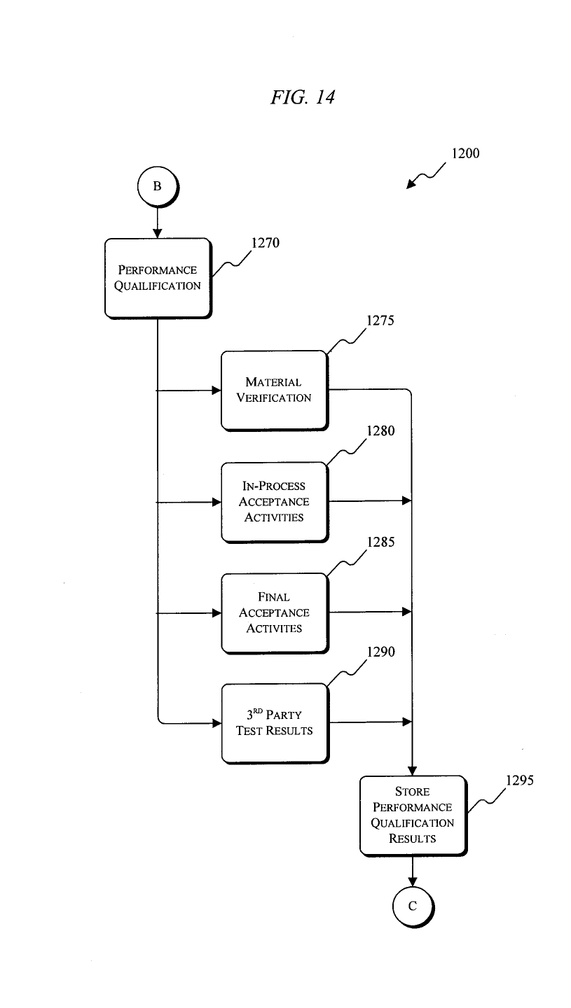

In FIG. 13, the operational qualification is initiated at step 1225. Operational qualification involves validating manufacturing processes to determine the effects that the manufacturing processes have on a material. The manufacturing processes include, for example, straightening operations, grinding operations, turning operations, chamfering operations, sawing operations, heat treatments, etc. A risk assessment with respect to each of the operations is performed at step 1230 to determine a level of risk associated with performing each process. In the illustrated embodiment, the results of the risk assessment for each manufacturing process are analyzed with respect to material grade (step 1235), material size (step 1240), mechanical properties (step 1245) (e.g., tensile strength, elongation, etc.), and surface condition (step 1250). A worst-case analysis is performed (step 1255) with respect to worst-case processing parameters and worst-case machine conditions to determine the worst-case effects of the manufacturing process on the material. The results of the worst-case analysis can be stored in, for example, the risk analysis database section 910 (FIG. 9) (step 1260). The results of the operational qualification validation can be stored in the validation database section 1105 (FIG. 11) (step 1265). The data and logic (described above with respect to FIG. 9) are used by the MRPM 325 to ensure that an end product conforms to any relevant standards (e.g., federal, international, etc.). Following step 1265, the process 1200 proceeds to section C shown in and described with respect to FIG. 14.

In FIG. 14, the performance qualification is initiated at step 1270. The performance qualification involves establishing, with a high degree of assurance, that the manufacturing processes consistently produce a product that meets established specifications (e.g., within the worst-case specifications determined during operational qualification). In the illustrated embodiment, performance qualification is performed with respect to material verification (e.g., size, straightness, etc.) (step 1275), in-process acceptance activities (step 1280), final acceptance activities (step 1285), and third party test results (step 1290). The requirements for in-process acceptance activities and final acceptance activities are set forth in the FDA 820 regulations. The third party test results are used to independently verify the quality and compliance of a purchased product. For example, third party testing provides an additional layer of product validation, which can be used to minimize risks associated with manufacturing, ensure compliance with medical customer's requirements, and verify materials for medical implants are compliant with federal and industry standards. The third party test results can be entered into the system 100 and associated with, for example, grade information in the vendor database section 605. In some embodiments, the system 100 can automatically analyze finished products (e.g., using a variety of sensors and detection techniques) to validate the performance of the manufacturing equipment and processes.

Following each of steps 1275-1290, the performance validation results are stored in, for example, the validation database section 1105 (FIG. 11) (step 1295). Following step 1295, the process 1200 can return to installation qualification (step 1205). As such, the process 1200 can be continually or regularly performed with respect to the equipment, software, and processes involved in the manufacturing process (e.g., following changes to a material specification, manufacturing process, equipment, software, etc.). The results of the validation can be stored or updated in the validation database section of the validation module to allow the system 100 to generate FDA compliance reports (e.g., device history record [“DHR”] reports, device master record [“DMR”] reports, quality system record [“QSR”] reports, etc.), quality audit reports, etc., automatically.

After the MRPM 325 has received information and data (or accessed information and data) from each of the customer management module 305, the vendor management module 310, the risk management module 315, and the validation module 320, the MRPM 325 is configured to process that information and data to determine which materials, material grades, vendors, manufacturing equipment, manufacturing processes, etc., should be used to fulfill a customer's purchase order and generate a corresponding quote. A process 1300 for quote generation is illustrated in and described with respect to FIGS. 15 and 16. The process 1300 is executed by, for example, the MRPM 325 within the controller 140. The process 1300 is illustrative of a process for quote generation. However, various steps described herein with respect to the process 1300 are capable of being executed simultaneously, in parallel, or in an order that differs from the illustrated serial manner of execution.

As described above, each of the customer management module 305, the vendor management module 310, the risk management module 315, and the validation module 320 are configured to access, retrieve, and provide information and data associated with a received purchase order to the MRPM 325. In some embodiments, the MRPM 325 accesses the information from the customer management module 305, the vendor management module 310, the risk management module 315, and the validation module 320. The process 1300 begins when a purchase order is received from a customer (step 1305). As described above, the purchase order can be received electronically from any of a variety of sources, such as devices 105-125, and the purchase order can be processed (step 1310) (e.g., automatically processed) to extract information from the purchase order. Additionally or alternatively, the information from the purchase order can be manually entered into the MRPM 325 using, for example, the user interface 170.

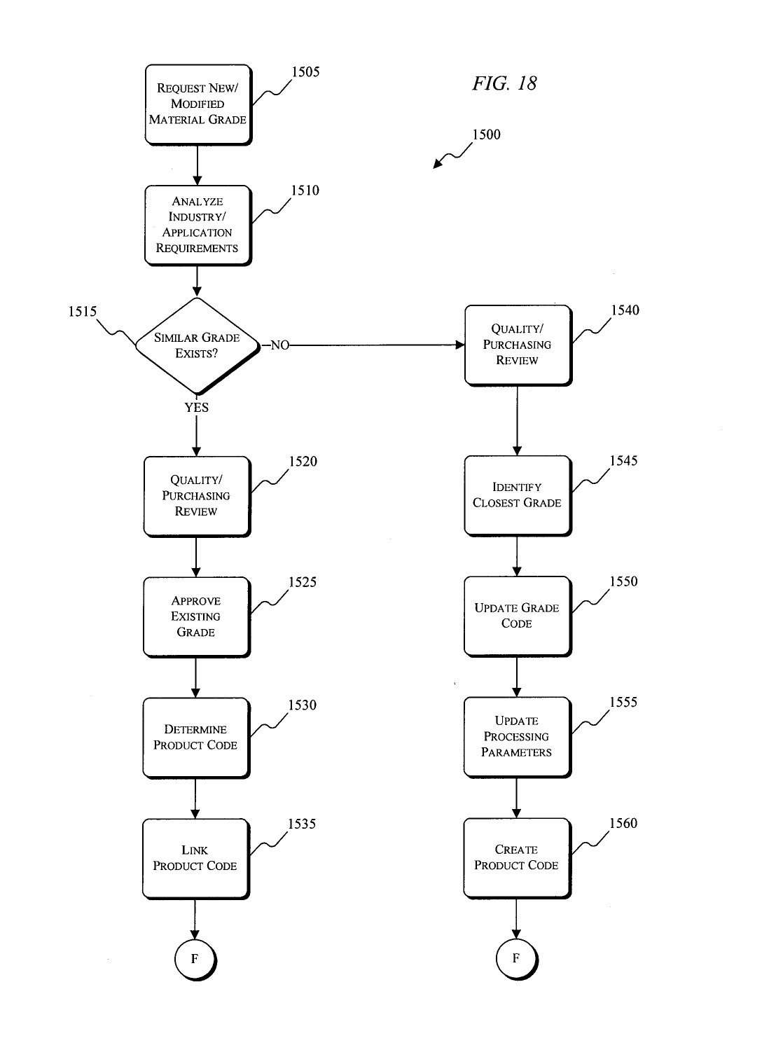

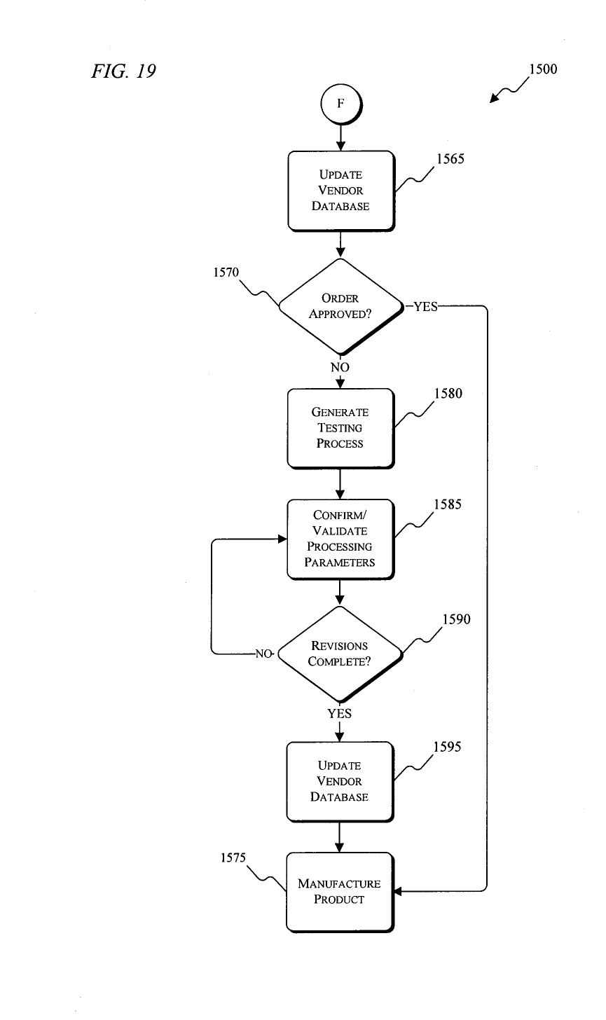

Based on the information within the purchase order, a customer is identified (step 1315). The customer can be identified using, for example, a customer name, a customer number, an address, a phone number, etc. After the customer has been identified, a set of customer data is retrieved or received (step 1320) by the customer module 335 from the customer management module 305 and customer database section 405. The customer data includes, among other things, customer restrictions, customer requirements, PPF information, application information, etc. The customer restrictions can identify disallowed countries of origin, disallowed melt sources, disallowed finishing mills, disallowed vendors, etc., as described above with respect to FIGS. 4 and 5. For example, materials sold to medical customers can only be purchased from approved medical vendors. The requirement for a vendor to be an approved medical vendor can be manually overridden with respect to general medical applications (e.g., tools, instruments, etc.). However, if the product is for medical implantation, the requirement cannot be overwritten. The materials (e.g., stainless steel, CCM, titanium, plastics, etc.) associated with the purchase order are then identified (step 1325). In some embodiments, the purchase order can include a custom recipe or grade for a material which can be compared to existing grades in the vendor database section 605. An existing grade can then be updated or a new material grade can be created and stored to the vendor database section 605, as described below with respect to FIGS. 18 and 19. Using information from the purchase order and the retrieved customer data, vendors can be selected (step 1330) and a set of vendor data is retrieved or received by the vendor module 340 from the vendor management module 310 and vendor database section 605 (step 1335). The vendor data is used to identify potential vendors of the materials. Each vendor is compared to the restrictions, requirements, and other customer data to determine whether the vendor is certified (step 1340) to provide the material for a given application. If a vendor is not a certified vendor, another vendor is selected at step 1330. If the vendor is a certified vendor, the process 1300 proceeds to section D shown in and described with respect to FIG. 16.

The determination of whether a vendor is certified involves a number of comparisons between the retrieved customer data and retrieved vendor data. For example, if the purchase order is related to a medical implant, the vendor must be certified to provide materials for medical implant applications. In some embodiments, indications can be provided to a user related to whether a particular vendor can provide a particular material grade (e.g., in the vendor management interface). Additionally, the vendor must not correspond to client restrictions or requirements related to, for example, the disallowed countries of origin, disallowed vendors, disallowed melt sources, disallowed finishing mills, etc. If the vendor satisfies each of the customer's restrictions and requirements for a particular application, the vendor can be determined to be an approved vendor.

At step 1345 in FIG. 16, the material grades and/or heats from the vendor are selected, and a set of risk data is retrieved or received from the risk management module 315 (step 1350). In some embodiments, a purchase order may specify a material grade and/or heat. In such embodiments, the requested material grade can be identified in the vendor database section 605. The risk data includes the worst-case FMEA analysis (e.g., the RPN) for one or more grades of the material, sizes of the material, mechanical properties of the material, surface conditions of the material, etc. The risk data also includes logic (described above with respect to FIG. 9) associated with the application of the material such that a grade of material having appropriate size, mechanical properties, surface condition, etc., following manufacturing can be selected. If the risk data indicates that the selected heat within a grade of material is not acceptable (step 1355) for the application (e.g., the heat is outside of a specified tolerance for a material characteristic), another heat is selected and steps 1345-1355 are repeated. In some embodiments, if a certified vendor is not able to provide any heat within a material grade that is acceptable for a given application, the process 1300 can return to step 1330 to select a new vendor. For example, if the selected material grade is the vendor's last available grade and is not acceptable (step 1360), the process returns to step 1330 in FIG. 15.

If, at step 1355, the selected material grade/heat is acceptable for the application, a set of validation data associated with the equipment, software, and processes required to manufacture the material as desired, and the performance thereof, is retrieved or received from the validation module 320 (step 1365). The validation data is then evaluated to determine whether the associated equipment/software is validated (i.e., IQ) (step 1370), whether the processes are validated (i.e., OQ) (step 1375), and whether the performance of the equipment, software, and processes are validated (i.e., PQ) (step 1380). If any of the equipment/software, processes, or performance are not validated for an application that requires validation (e.g., an application administered by the FDA), the process 1300 proceeds to step 1345 for the selection of a new material grade. In some embodiments, if the equipment, software, processes, or performance are not validated, the process 1300 can return to step 1330 to select a new vendor, as previously described. If each of the equipment/software, processes, and performance are validated, a quote is generated (step 1385). In some embodiments, the steps 1370, 1375, and 1380 of the process 1300 are not required for quote generation. The steps 1370, 1375, and 1380 are included in the illustrated process 1300 for applications, such as medical implant applications, in which compliance with FDA 820 or other regulations is necessary.

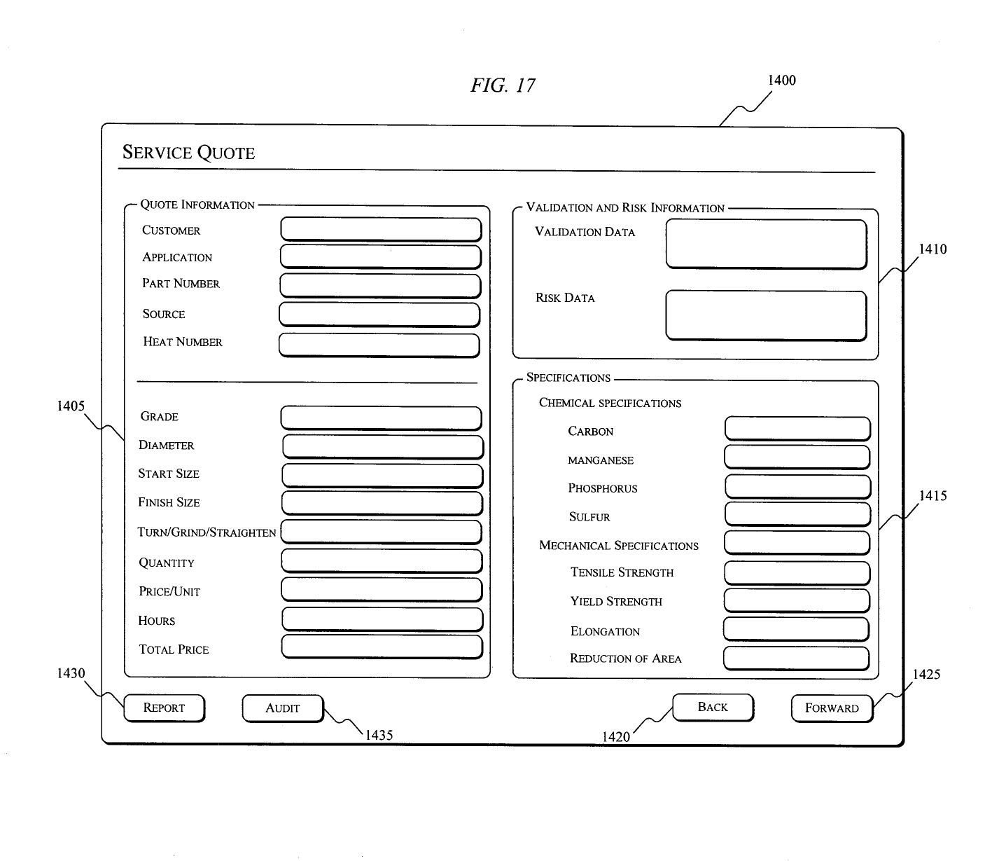

Following the generation of a quote (e.g., a service quote) as described above with respect to the process 1300 of FIGS. 15 and 16, the quote can be, for example, stored to the memory 190, transmitted to a customer (e.g., via email, facsimile, etc.) over the first network 130 or the second network 135 to one of the devices 105-125. Additionally or alternatively, the quote can be accessed and viewed using a service quote interface, such as the service quote or quotation interface 1400 illustrated in FIG. 17. The service quote interface 1400 includes a quote information section 1405, a validation and risk information section 1410, and a special specification section 1415.

The quote information section 1405 provides information such as customer, application, part number, source (of material), and heat number. The quote information section also includes, for example, turn/grind/straighten information, grade, diameter (of material), start size, finish size, quantity ordered, price per unit, hours involved in manufacturing, and a total price. The validation and risk data section 1410 includes any relevant validation information (e.g., installation qualification, operational qualification, and performance qualification) or acknowledgments. The validation and risk data section 1410 also includes risk data associated with, for example, the worst-case analysis, RPN, etc. The specifications section 1415 includes information related to chemical specifications (e.g., chemical composition) and mechanical specifications (e.g., tensile strength, yield strength, elongation, and reduction of area) of a requested material. In some embodiments, the service quote interface 1400 includes additional sections or additional screens which can be navigated using a “BACK” button 1420 and a “FORWARD” button 1425.

The service quote interface 1400 also includes a report button 1430 that can be selected to generate a complete report associated with the quote. For example, the report can include a copy of the purchase order, customer data (e.g., restrictions, requirements, etc.), vendor data (e.g., certifications), validation data (e.g., installation qualification, operational qualification, and performance qualification reports), and the risk data (e.g., worst-case analysis and logic associated with material selection), etc. The service quote interface 1400 also includes an audit button 1435. The audit button 1435 can be selected to generate, for example, an audit report related to the compliance with FDA 820, ISO 13485, etc. In some embodiments, the service quote interface 1400 is accessible by, for example, the customer access portal 415 over the networks 130 and 135.

In addition to generating a service quote based on a purchase order as described above, the system 100 is also configured to, for example, update the vendor database section 605 with new or modified material grades based on a received purchase order or another input to the controller 140 and MRPM 325. Such a process 1500 for updating the vendor database section 605 with a new or modified material grade is illustrated in FIGS. 18 and 19. At step 1505, a request for a new or modified material grade is received (e.g., in a purchase order). The industry or application specific requirements associated with the request are then analyzed (step 1510). For example, the requirements associated with a material for use in a medical implant application are reviewed. Similarly, if the requested new or modified material grade is associated with an automotive or aerospace application, corresponding requirements can be reviewed. Based on the requested material grade and the associated industry or application requirements, a determination is made regarding whether a similar material grade is currently in the vendor database section 605 (step 1515). For example, a similar material grade for an automotive application may be included in the system 100, but such a grade may not be approved for use in medical applications. If a similar grade exists, a quality or purchasing review is performed (step 1520). The quality or purchasing review relates to, for example, new specifications of the material grade, the machinability of the material grade, the source of the material (e.g., country of origin, melting source, etc.), etc.

If it is determined that the requested new or modified material grade will have no effect (e.g., adverse effect) on the processing of the material, the existing material grade can be approved for use as the new or modified material grade (step 1525). Following step 1525, a product code is determined (step 1530). Determining the product code can include identifying an existing product code or creating a new product code. If an existing product code is identified, the attributes of the material grade can be updated to include, for example, a new application of the material. If a new product code is created, the new grade code is linked to the approved material grade (e.g., a grade code corresponding to the approved material grade) (step 1535), and the process proceeds to section F shown in and described with respect to FIG. 19.

If, at step 1515, no similar grade exists, a quality or purchasing review is performed (step 1540). The quality or purchasing review relates to, for example, the new specifications of a material grade, the machinability of the material grade, the source of the material (e.g., country of origin, melting source, etc.), etc. The most similar grade within the vendor management module 310 is then identified (step 1545) and copied to generate a new material grade code. The new material grade code is then updated with the specifications of the requested material grade (e.g., mechanical properties, chemical properties, etc.) (step 1550). Following step 1550, a set of processing parameters for the new material grade are selected or updated (step 1555), and a new product identification code is generated and linked to the new grade code (step 1560). The process then proceeds to section F shown in and described with respect to FIG. 19.

At step 1565 in FIG. 19, the vendor database section 605 is updated with the new or modified material grade (i.e., product code, material grade code, etc.). However, before the material grade can be sold, the processing of the new material grade is validated or approved. At step 1570, the new or modified material grade is compared to, among other things, vendor certificates in the vendor database section 605 to determine whether a vendor is able to provide the new or modified material grade. If a vendor is able to provide the material grade (e.g., in compliance with the above described processes for determining whether a vendor can provide a material), the order can be approved and the product is manufactured (step 1575). If no vendors are able to provide the material grade based on, for example, existing certificates in the vendor database section 605, a testing process is generated (step 1580) to confirm and validate that the processing parameters produce a desired product (step 1585). After any necessary revisions (step 1590) to the processing parameters of the material grade are complete and the processing parameters for the material grade produce the desired product, the vendor database section 605 is updated with the new processing parameters and any new vendor certificates related to the new or modified material grade (step 1595). The product can then be manufactured (step 1575).

Thus, the invention provides, among other things, supply chain management of a manufacturing process based on client data, vendor data, risk data, and validation data to generate a service quote or control manufacturing equipment. Various features and advantages of the invention are set forth in the following claims.

What is claimed is:

1. A system for managing a manufacturing supply chain to fulfill an order for a medical grade material and generate a corresponding service quote, the system comprising:
a customer database configured to store a set of customer data for each of a plurality of customers;
a vendor database configured to store a set of vendor data for each of a plurality of vendors, the set of vendor data including at least one raw material capable of being supplied by the vendor, the at least one raw material having an associated raw material characteristic;
a risk analysis database configured to store a set of risk analysis data related to at least one manufacturing process, the risk analysis data associated with an effect on the at least one raw material by the at least one manufacturing process; and
a controller including a resource planning module, the controller configured to
receive the order for the medical grade material from one of the plurality of customers, the medical grade material having an attribute and being associated with the at least one manufacturing process,
retrieve the set of customer data associated with the one of the plurality of customers from the customer database,
select one of the plurality of vendors to provide the at least one raw material based on the set of vendor data stored in the vendor database, a comparison of the attribute of the medical grade material to the raw material characteristic, and the risk analysis data in the risk database associated with the effect on the at least one raw material by the manufacturing process, and
generate the service quote based on the comparison of the attribute of the medical grade material to the raw material characteristic, the service quote including the attribute of the medical grade material, the selected one of the plurality of vendors, and the raw material characteristic.

2. The system of claim 1, further comprising a validation database configured to store a set of process validation information related to the at least one manufacturing process.

3. The system of claim 1, wherein the raw material characteristic is indicative of the capability of the raw material to be used in a medical application.

4. The system of claim 3, wherein the medical application is a medical implant.

5. The system of claim 1, wherein the set of customer data associated with the one of the plurality of customers includes a customer restriction excluding at least one of the plurality of vendors from providing the raw material.

6. The system of claim 1, wherein the manufacturing process is one of a turning process, a straightening process, a grinding process, a sawing process, a chamfering process, a heat treating process, and a plating process.

7. The system of claim 1, wherein the raw material is one of stainless steel, carbon steel, aluminum, brass, cobalt-chrome-molybdenum, titanium, and plastic.

8. A computer-implemented method of fulfilling an order for a material, the method comprising:
storing, in a vendor database, vendor data relating to a plurality of raw material vendors, the vendor data including vendor attribute data related to at least one attribute of the vendor and raw material attribute data related to at least one attribute of a raw material;
receiving an order for the material from a customer;
storing, in a customer database, customer data relating to the customer, the customer data including customer requirements data related to at least one customer requirement for the material;
determining, by a processor, whether the at least one attribute of the raw material is indicative of the raw material being capable of being used in a medical device; and
determining, by the processor, order fulfillment information including a vendor among the plurality of raw material vendors and the raw material,
wherein the order fulfillment information is determined based on the stored customer data and the determination of whether the at least one attribute of the raw material is indicative of the raw material being capable of being used in the medical device.

9. The method of claim 8, further comprising storing, in a risk analysis database, a set of risk analysis data related to at least one manufacturing process, the risk analysis data related to an effect on the raw material by the at least one manufacturing process.

10. The method of claim 9, wherein the at least one manufacturing process is one of a turning process, a straightening process, a grinding process, a sawing process, a chamfering process, a heat treating process, and a plating process.

11. The method of claim 10, further comprising storing, in a validation database, a set of process validation information related to the at least one manufacturing process.

12. The method of claim 8, wherein the medical device is a medical implant.

13. The method of claim 8, wherein the raw material is one of stainless steel, carbon steel, aluminum, brass, cobalt-chrome-molybdenum, titanium, and plastic.

14. A method of processing an order for a material and generating a service quote, the method comprising:
storing a set of customer data relating to each of a plurality of customers in a customer database, the set of customer data including one or more customer specifications related to the material, the one or more customer specifications including at least one customer attribute of the material related to an application of the material; and
storing a set of vendor data relating to each of a plurality of raw material vendors in a vendor database, the set of vendor data including at least one vendor attribute for each of the plurality of vendors, at least one raw material the vendors are capable of supplying, and at least one raw material attribute associated with the at least one raw material;
receiving the order for the material from one of the plurality of customers;
accessing the at least one customer attribute from the customer database;
accessing the at least one vendor attribute and the at least one raw material attribute from the vendor database;
comparing the at least one customer attribute to the at least one raw material attribute for each of the plurality of vendors;
determining which of the plurality of raw material vendors is capable of supplying the raw material based on the vendor attribute; and
selecting at least one of the plurality of vendors to supply the raw material based on the determination of which of the plurality of raw material vendors is capable of supplying the raw material and the comparison.

15. The method of claim 14, further comprising storing a set of risk analysis data related to at least one manufacturing process in a risk analysis database, the risk analysis data related to an effect on the raw material by the at least one manufacturing process.

16. The method of claim 15, wherein the at least one manufacturing process is one of a turning process, a straightening process, a grinding process, a sawing process, a chamfering process, a heat treating process, and a plating process.

17. The method of claim 16, further comprising storing a set of process validation information related to the at least one manufacturing process in a validation database.

18. The method of claim 14, wherein the application of the material is a medical application.

19. The method of claim 18, wherein the medical application is a medical implant.

20. The method of claim 19, wherein the raw material attribute is indicative of the capability of the raw material to be used in the medical implant.
